(19) United States
(12) Patent Application Publication
(10) Pub. No.: US 2025/0153324 A1
(43) Pub. Date: May 15, 2025

(54) REBAR TYING TOOL, REBAR TYING METHOD, AND METHOD OF USING THE REBAR TYING TOOL

(71) Applicant: MAKITA CORPORATION, ANJO-SHI (JP)

(72) Inventors: Takuma IWATANI, Anjo-Shi (JP); Makoto CHIKARAISHI, Anjo-Shi (JP)

(21) Appl. No.: 18/931,281

(22) Filed: Oct. 30, 2024

(30) Foreign Application Priority Data
Nov. 9, 2023 (JP) 2023-191470

(51) Int. Cl. B25B 25/00; E04G 21/12

(52) U.S. Cl. CPC B25B 25/00; E04G 21/123

(57) ABSTRACT

A rebar tying tool includes: a twisting motor, which actuates a twisting member that twists a wire, which has been wound around rebars; a main-body housing, which houses the twisting motor; and a first illumination member, which is held on the main-body housing and shines light toward the rebar. A method for tying the rebars using the wire includes first shining light emitted from the rebar tying tool toward the rebars and then twisting the wire, which has been wound around the rebars.

### CROSS-REFERENCE TO RELATED APPLICATION

This application claims priority to Japanese patent application no. 2023-191470 filed on Nov. 9, 2023, the contents of which are fully incorporated herein by reference.

### TECHNICAL FIELD

The present specification relates to a rebar tying tool, a rebar tying method, and a method of using the rebar tying tool.

### BACKGROUND ART

A rebar tying tool is disclosed in U.S. Pat. No. 10,570,620 (B2) and DE 10 2017 100 949 (A1). This rebar tying tool comprises a twisting motor, which drives a twisting member that twists a wire, which has been wound (looped) around two or more reinforcing bars (rebars), and a main-body housing, which houses the twisting motor.

### SUMMARY OF THE INVENTION

When using the above-mentioned rebar tying tool in a dark location, it might be difficult to see the rebars. Therefore, it is one non-limiting object of the present teachings to disclose techniques for making it easier to see rebars, as well as to optionally also avoid the generation of distracting shadows, when using a rebar tying tool in a dark location.

In one non-limiting aspect of the present teachings, a rebar tying tool may comprise: a twisting motor, which drives a twisting member (mechanism) that twists (and thereby fastens) a wire, which has been wound (looped) around two or more reinforcing bars (rebars); a main-body housing, which houses the twisting motor; and a first illumination member, which is held on the main-body housing and shines light toward the rebars.

According to the above-mentioned configuration, when using the rebar tying tool in a dark location, the rebars are illuminated by the light from the first illumination member. Thereby, the rebars can be made easier to see.

In another non-limiting aspect of the present teachings, a rebar tying method is disclosed that uses a wire to tie rebars. The rebar tying method comprises shining light emitted from a rebar tying tool toward the rebars and twisting a wire, which has been wound (looped) around two or more rebars, in the state in which the light is illuminating the rebars.

According to the above-mentioned configuration, the rebars can be made easier to see when tying rebars in a dark location.

In another non-limiting aspect of the present teachings, a method of using a rebar tying tool, which uses a wire to tie rebars, is disclosed. The rebar tying tool preferably comprises: a twisting motor, which drives a twisting member that twists a wire, which has been wound (looped) around two or more rebars; a trigger, which is manipulated (squeezed, pulled) by a user to actuate the twisting motor (after the rebar tying tool has wound the wire around the rebars); a first illumination member, which shines light toward the rebars; and an actuating part, which actuates (energizes, turns ON) the first illumination member. This method of use preferably comprises actuating the first illumination member by using the actuating part, and (preferably subsequently and then simultaneously) driving the twisting motor in response to manipulation (squeezing, pulling) of the trigger by the user. In a preferred embodiment, the first illumination member is actuated (illuminated) at least prior to driving the twisting motor (and also preferably prior to initiation of a wire looping operation) and then is optionally continuously actuated (illuminated) during a (the) wire looping operation and subsequent wire end twisting operation, so that the user can easily see the rebars to be tied, e.g., in a dark location, at least prior to initiating the rebar tying method but also optionally also during the performance of the entire rebar tying method (i.e. looping, cutting and twisting the wire).

According to the above-mentioned configuration, the rebars are illuminated by the light from the first illumination member. Thereby, the rebars can be made easier to see when tying rebars in a dark location.

### BRIEF DESCRIPTION OF THE DRAWINGS

FIG. 1 is an oblique view of a rebar tying tool 2 according to Working Example 1.

FIG. 2 is a left view of the rebar tying tool 2 according to Working Example 1 in the state in which a left-side housing 8 and a reel cover 10 have been removed.

FIG. 3 is an oblique view of the rebar tying tool 2 according to Working Example 1 in the state in which the reel cover 10 is open.

FIG. 4 is a cross-sectional view of an illumination member 104 according to Working Example 1.

FIG. 5 is an enlarged, front view of a guide-member holding part 14 of the rebar tying tool 2 according to Working Example 1.

FIG. 6 is a schematic diagram showing an aspect in which light emitted by a first illumination member 100 and a second illumination member 102 according to Working Example 1 illuminates one rebar R.

FIG. 7 is a schematic diagram showing an aspect in which light emitted by the first illumination member 100 and the second illumination member 102 according to Working Example 1 illuminates another rebar R that is orthogonal to and crosses the rebar R shown in FIG. 6.

FIG. 8 is a flow chart showing a process executed by a control unit 58 according to Working Example 1.

FIG. 9 is a cross-sectional view of the illumination member 104 according to Working Example 2.

FIG. 10 is a left view of the rebar tying tool 2 according to Working Example 3 in the state in which the left-side housing 8 and the reel cover 10 have been removed.

FIG. 11 is a left view of the rebar tying tool 2 according to Working Example 4.

FIG. 12 is a front view of the rebar tying tool 2 according to Working Example 5.

FIG. 13 is a front view of the rebar tying tool 2 according to Working Example 6.

FIG. 14 is an oblique view of the rebar tying tool 2 according to Working Example 7.

FIG. 15 is a left view of the rebar tying tool 2 according to Working Example 7 in the state in which the left-side housing 8 has been removed.

FIG. 16 is an enlarged, front view of the guide-member holding part 14 of the rebar tying tool 2 according to Working Example 7.

FIG. 17 is a front view of the rebar tying tool 2 according to Working Example 8.

FIG. 18 is a front view of the rebar tying tool 2 according to Working Example 9.

FIG. 19 is a left view of the rebar tying tool 2 according to Working Example 10.

### DETAILED DESCRIPTION

Representative, non-limiting detailed examples of the present invention are described in detail below, with reference to the drawings. This detailed explanation is intended merely to teach a person skilled in the art further details for implementing preferred aspects of the present teachings, and is not intended to limit the scope of the present invention. In addition, each of the additional features and teachings disclosed below can be used separately from or together with other features and teachings to provide further improved rebar tying tools, rebar tying methods, methods of using the rebar tying tool, and methods of manufacturing the rebar tying tool.

In addition, combinations of features and processes (steps) disclosed in the detailed explanation below may not be essential to carry out the present invention in the broadest sense and are instead taught only to describe representative examples of the present teachings in greater detail. Furthermore, in providing additional and useful embodiments of the present teachings, the various features of the representative examples described above and below and the various features recited in the independent and dependent claims do not necessarily have to be combined as described in the working examples below or as described in the sequence enumerated herein.

All features recited in the present specification and/or in the claims are intended, separately from the configuration of features recited in the working examples and/or the claims, to be disclosed individually and mutually independently as limitations relative to the specific matters disclosed and claimed herein. Furthermore, descriptions relating to all numerical ranges, groups, and collections are intended to disclose intermediate ranges, configurations, etc. thereof as limitations relative to the specific subject matters disclosed and the claimed herein.

Rebar tying tools disclosed in the present specification typically comprise: a twisting motor, which drives (is configured to (mechanically) drive) a twisting member (mechanism) that twists (is configured to twist) a wire, which has been wound (looped) around two or more rebars (thereby tying two or more rebars together); a main-body housing, which houses the twisting motor; and a first illumination member, which is held on the main-body housing and shines (is configured to shine) light toward the rebars. As used herein, the phrase “twists a (the) wire around (the) rebars” is intended to be understood as meaning “twisting a (the) wire, which has been wound (looped) around (the) rebars.” The rebar tying tool may be configured to hold any portion of the wire, such as both ends of the wire or the middle of the wire, when twisting the wire.

In one or more embodiments, the first illumination member may comprise a (at least one) transmissive part, through which the light is transmitted from the interior of the first illumination member to the exterior of the first illumination member. In other words, light generated in the first illumination member passes through the (at least one) transmissive part before reaching the rebars. At least one dimension (e.g., the width) of the transmissive part, which is preferably the longest dimension of the transmissive part, may be larger than the diameter of the rebars to be tied together by the rebar tying tool. More specifically, the rebar-tying tool is preferably designed (configured, adapted, rated) to tie together rebars within a particular range of diameters, as will be further discussed below. Thus, at least one dimension of the transmissive part(s) is preferably at least larger than the largest rebar diameter that the rebar-tying tool is designed (rated) to tie together.

According to the above-mentioned configuration, because the at least one dimension (e.g., the width) of the light transmitted through the transmissive part is larger than the diameter of a rebar that is being tied together with at least one other rebar (which typically has the same diameter, but could, in principle, have a different diameter (e.g., in case first rebars extending in one direction have a diameter that differs from second rebars extending perpendicular (or at least oblique) to the first rebars)), the entirety of the rebar(s) in the width (diameter) direction of the rebar(s) can be effectively illuminated. Thereby, the rebar(s) can be made easier to see, e.g., in a dark location.

In one or more embodiments, the rebar tying tool may further comprise a guide member, which winds (loops) the wire around the rebars. The main-body housing may comprise a guide-member holding part that holds the guide member. The first illumination member may be disposed on the guide-member holding part.

According to the above-mentioned configuration, when using the rebar tying tool to tie rebars, the guide member is disposed proximate to the rebars. Consequently, the first illumination member is disposed proximate to the rebars. Thereby, the rebars can be made easier to see owing to the light from the first illumination member.

In one or more embodiments, the rebar tying tool may further comprise a second illumination member, which is held on the main-body housing and shines light toward the rebar(s). The first and second illumination members may preferably each have an elongated shape (e.g., the same elongated shape) and may preferably extend in parallel. In such embodiments, a longitudinal axis of the twisting member preferably passes perpendicularly between the first and second illumination members.

In at least some embodiments having the above-mentioned configuration(s), the rebar(s) can be made easier to see than in a configuration in which only a single illumination member is provided on the rebar tying tool.

In any of such configurations, the rebar tying tool may further comprise a (the) guide member, which winds (loops) the wire around the rebars, as was mentioned above. The main-body housing may also comprise a (the) guide-member holding part that holds a (the) guide member. A (the) first illumination member and a (the) second illumination member may be both disposed on the guide-member holding part.

In such configurations as well, when using the rebar tying tool to tie rebars, the guide member is disposed proximate to the rebars. Consequently, both the first illumination member and the second illumination member are disposed proximate to the rebars. Thereby, the rebars can be made easier to see because the light from both the first illumination member and the second illumination member shine on the rebars, preferably in a crossing (cross fire) or intersecting manner, thereby avoiding or minimizing any shadow(s) that may be present on a surface on the opposite side of the rebars from the rebar tying tool, as will be further explained below.

In one or more embodiments, the rotor of the twisting motor may rotate about a central axis which extends in, or in parallel with, a front-rear direction. When viewing the rebar tying tool in the front-rear direction, the guide member may be disposed between the first illumination member and the second illumination member in a left-right direction, which is orthogonal to the front-rear direction.

According to the above-mentioned configuration, when using the rebar tying tool to tie rebars, the light from the first illumination member and the light from the second illumination member both illuminate the rebars, again preferably in a crossing (cross fire) or intersecting manner. In comparison, if the rebars were to (hypothetically) be illuminated by the light from only the first illumination member, a first shadow might be formed on a wall surface on the far side of the rebars due to the rebar blocking a portion of the light from the first illumination member. However, because the present configuration also includes the above-described second illumination member, a portion of the light from the second illumination member can be directed or oriented to illuminate the area of the surface behind the rebars that would otherwise fall within the first shadow, such that there may be no first shadow or the first shadow will be barely noticeable (perceptible). Similarly, if (in the alternative) the rebars were to (hypothetically) be illuminated by the light from only the second illumination member, a second shadow might be formed on the wall surface on the far side of the rebars. However, because the present configuration also includes the above-described first illumination member, a portion of the light from the first illumination member can be directed or oriented to illuminates the area of the surface behind the rebars that would otherwise fall within the second shadow, such that there may be no second shadow or the second shadow also will be barely noticeable (perceptible). Accordingly, the first and second shadows, which might otherwise be formed on the surface on the far side of (behind) the rebars, can be made to be not noticeable or even entirely eliminated. In addition, even if first and second shadows form on the surface behind the rebar and move when the user rotates the rebar tying tool relative to the surface behind the rebars, the user is not likely to be distracted by the (barely noticeable) first and second shadows.

In one or more embodiments, when viewing the rebar tying tool in the front-rear direction, the twisting member (or at least a longitudinal and/or rotational axis thereof) may be disposed (e.g., entirely) between the first illumination member and the second illumination member in the left-right direction, which is orthogonal to the front-rear direction.

According to the above-mentioned configuration, the first and second shadows, which might form on the surface on the far side of the rebars, can be made less noticeable or entirely eliminated when tying rebars.

In one or more embodiments, the distance between the first illumination member and the second illumination member may be larger than the diameter of the rebars being tied together.

According to the above-mentioned configuration, the first and second shadows, which might form on the surface on the far side of the rebar, can be made even less noticeable or entirely eliminated when tying rebars because the above-noted arrangement facilitates a continuous illumination (i.e. without or with minimal shadows) of both the rebars and the surface behind the rebars.

In one or more embodiments, the luminous flux of the light emitted by the first illumination member (and optionally also the second illumination member, if present) may be 1 lumen or more and 10,000 lumens or less.

According to the above-mentioned configuration, the rebar(s) can be made easier to see owing to a sufficiently strong light from the first illumination member (and optionally also the second illumination member, if present).

In one or more embodiments, the luminous-flux intensity of the light emitted by the first illumination member (and optionally also the second illumination member, if present) may be 70 lux or more and 3,000 lux or less at a location that is 150 mm from the first illumination member (and optionally also the second illumination member, if present) in a direction of irradiation of the light.

According to the above-mentioned configuration, the rebar(s) can be made easier to see owing to a sufficiently strong light from the first illumination member (and optionally also the second illumination member, if present).

In one or more embodiments, the first illumination member (and optionally also the second illumination member, if present) may (each) comprise: a light-emitting part, which emits light; and a diffusion part, which diffuses the light emitted by the light-emitting part.

According to the above-mentioned configuration, the range of irradiation of the light from the first illumination member (and optionally also the second illumination member, if present) can be made larger than a (hypothetical) configuration in which the first illumination member (and optionally also the second illumination member, if present) does not comprise the diffusion part owing to the light scattering by the diffusion part.

In one or more embodiments, the rebar tying tool may further comprise: a control unit, which drives the twisting motor; and a lead line (conductive wire), which electrically connects the first illumination member with the control unit. The main-body housing may comprise a grip part, which is (configured to be) gripped (held) by a user when the user is using the rebar tying tool. The lead line passes through the interior of the grip part.

According to the above-mentioned configuration, the space inside the grip part can be utilized effectively.

In one or more embodiments, the rebar tying tool may further comprise: a feed motor, which drives a feed member that feeds the wire (to the guide member); a control unit, which drives the twisting motor and the feed motor; and a lead line (conductive wire), which electrically connects the first illumination member with the control unit. The main-body housing may comprise a feed-motor housing part, which houses the feed motor. The lead line passes through the interior of the feed-motor housing part.

According to the above-mentioned configuration, the space inside the feed-motor housing part can be utilized effectively.

In one or more embodiments, the rebar tying tool may further comprise a control unit, which is capable of actuating (energizing, turning ON)) the first illumination member and driving (energizing) the twisting motor and executes a tying process that ties the wire around the rebars. The control unit may cause the first illumination member to emit light prior to executing the tying process.

According to the above-mentioned configuration, the rebar(s) can be made easier to see when tying rebars.

### Working Example 1

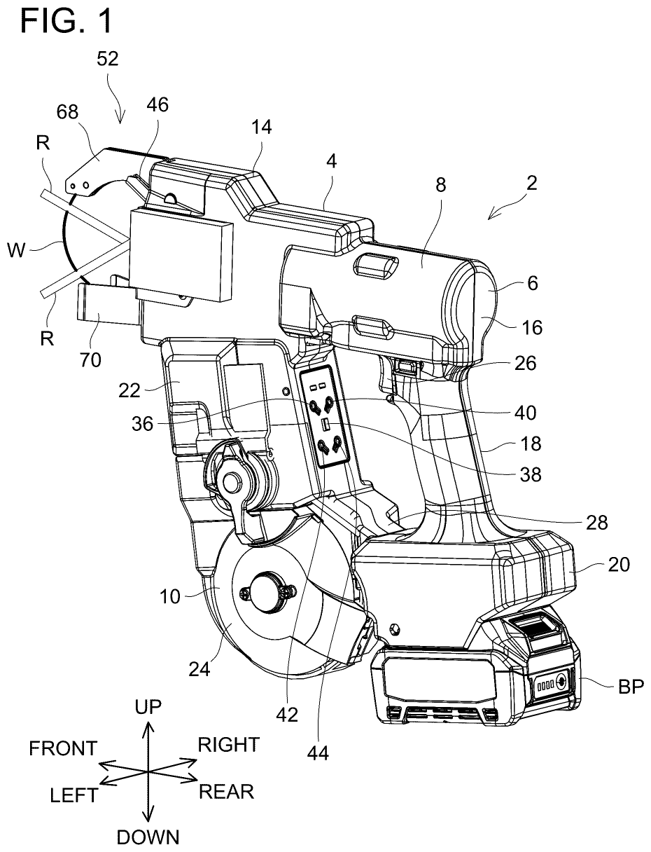

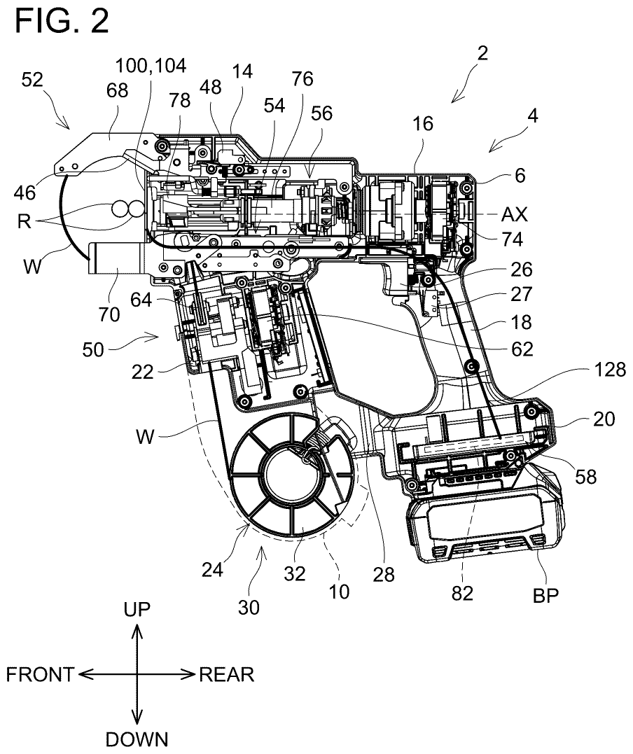

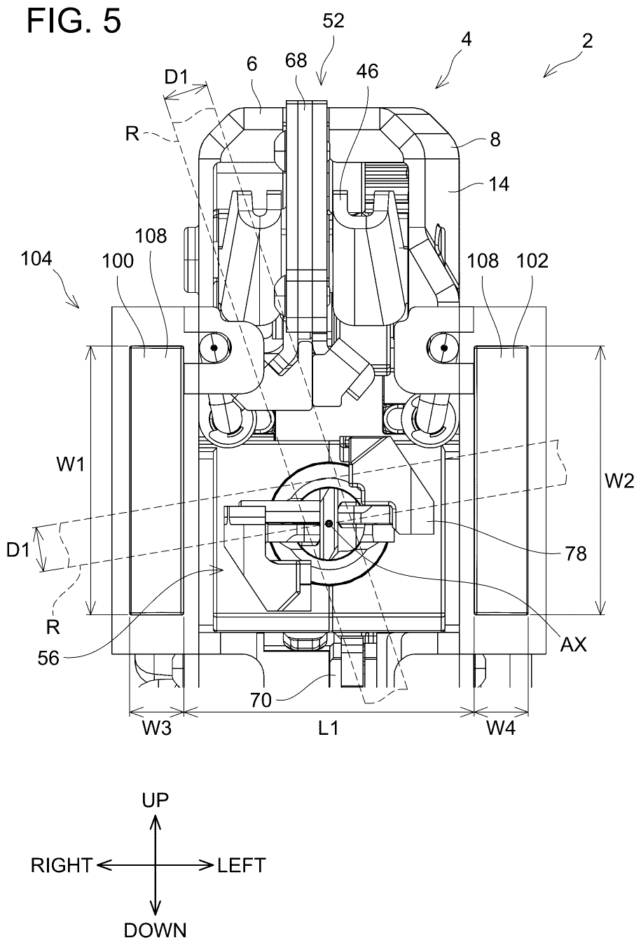

As shown in FIG. 1, a rebar tying tool 2 uses a wire W to tie together two or more (typically, two crossing) rebars R. Wires W of various diameters (e.g., diameters of 0.5-2.5 mm) are used by the rebar tying tool 2 in accordance with diameter D1 (see FIG. 5) of the rebars R being tied. For example, a wire W having a diameter of 1.6 mm or less (e.g., 0.8 mm) is used when tying small-diameter rebars R having diameter D1 of 16 mm or less (e.g., a diameter of 16 mm); and a wire W having a diameter of 1.6 mm or more (e.g., 2.0 mm) is used when tying large-diameter rebars R having diameter D1 larger than 16 mm (e.g., a diameter of 25 mm or 32 mm). Below, the longitudinal direction of a twisting unit 56 (see FIG. 2) is called the front-rear direction. More particularly, the longitudinal (rotational) direction of the rotor of a twisting motor 74, which drives the twisting unit 56, extends in, or in parallel with, the front-rear direction. In addition, a direction orthogonal to the front-rear direction is called the up-down direction, and a direction orthogonal to the front-rear direction and to the up-down direction is called the left-right direction.

The rebar tying tool 2 comprises a main-body housing 4 and a battery pack BP. The main-body housing 4 comprises: a right-side housing 6, which defines the external shape of a right-half surface of the main-body housing 4; a left-side housing 8, which defines the external shape of a left-half surface of the main-body housing 4; and a reel cover 10, which is mounted on a front-side, lower portion of the left-side housing 8 in a pivotable manner.

The main-body housing 4 comprises a guide-member holding (housing) part 14, a twisting-motor housing part 16, a grip part (handle) 18, a control-unit housing part 20, a feed-motor housing part 22, and a reel-housing part 24. The guide-member holding part 14, the twisting-motor housing part 16, the grip part 18, the control-unit housing part 20, and the feed-motor housing part 22 are formed by the right-side housing 6 and the left-side housing 8. The reel-housing part 24 is formed by the right-side housing 6, the left-side housing 8, and the reel cover 10.

As shown in FIG. 2, the guide-member holding part 14 extends in the front-rear direction. The twisting-motor housing part 16 is disposed on the rear side of the guide-member holding part 14. The grip part 18 is disposed on the lower side of the twisting-motor housing part 16. The grip part 18 is gripped by the user. The longitudinal direction of the grip part 18 is tilted slightly relative to the up-down direction. The rebar tying tool 2 comprises a trigger 26, which is mounted on a front-surface upper portion of the grip part 18 in a pullable (slidable) manner. When pulled or squeezed, the trigger 26 presses a trigger-detection switch 27 in the interior of the grip part 18.

The control-unit housing part 20 is disposed on the lower side of the grip part 18. The battery pack BP is mounted on a lower end of the control-unit housing part 20 in a detachable manner. The battery pack BP is mounted on the control-unit housing part 20 by sliding the battery pack BP toward a forward-lower side relative to the control-unit housing part 20 and is removed from the control-unit housing part 20 by sliding the battery pack BP toward a rearward-upper side relative to the control-unit housing part 20. The battery pack BP may comprise, for example, secondary (rechargeable) batteries, such as lithium-ion batteries.

The feed-motor housing part 22 is disposed on the lower side of the guide-member holding part 14. The feed-motor housing part 22 is disposed forward of the grip part 18 and is spaced apart from the grip part 18.

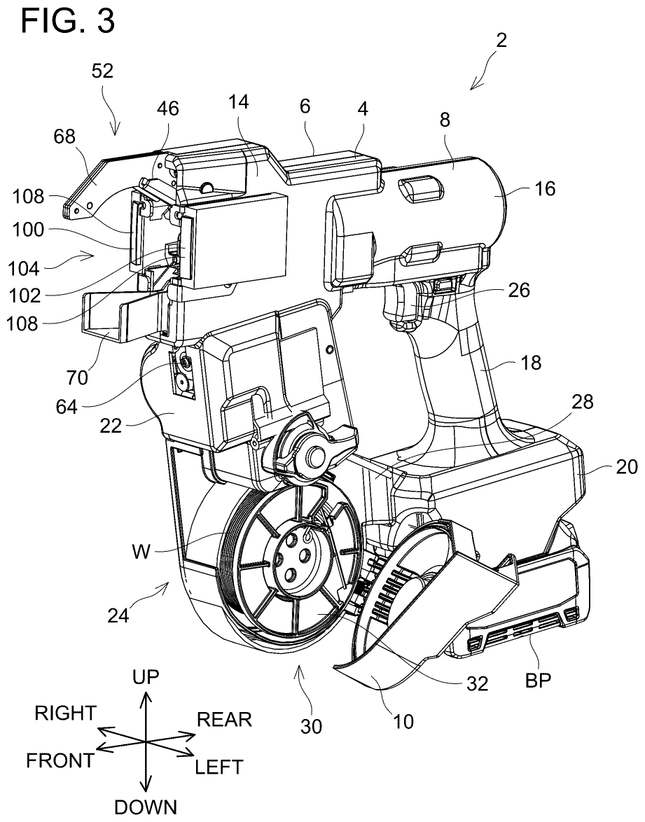

The reel-housing part 24 is disposed on the lower side of the feed-motor housing part 22. It is noted that the reel-housing part 24 is depicted with a broken line in FIG. 2. The reel-housing part 24 is connected to the front end of the control-unit housing part 20 via a connecting passage (conduit, tubular structure) 28. As shown in FIG. 3, the reel-housing part 24 is capable of housing a reel 30. The reel 30 comprises the wire W and a bobbin 32, onto which the wire W is wound. The reel 30 is held in the reel-housing part 24 in a rotatable manner. The reel 30 is detachable (removable) from the reel-housing part 24 when the reel cover 10 is opened relative to the left-side housing 8.

As shown in FIG. 1, the rebar tying tool 2 further comprises a main-power-supply switch (button) 36, a display part (display) 38, a mode-change switch (button) 40, a tying-strength increase switch (button) 42, and a tying-strength decrease switch (button) 44. The main-power-supply switch 36, the display part 38, the mode-change switch 40, the tying-strength increase switch 42, and the tying-strength decrease switch 44 are disposed on a rear surface of the feed-motor housing part 22. The main-power-supply switch 36 is manipulated by the user to switch the rebar tying tool 2 between the ON state and the OFF state. The rebar tying tool 2 is operatable when in the ON state. The rebar tying tool 2 is non-operatable when in the OFF state. The display part 38 displays information pertaining to the rebar tying tool 2. The display part 38 is seen by the user.

The mode-change switch 40 switches the mode of the rebar tying tool 2 between a single actuation mode and a continuous actuation mode. When the rebar tying tool 2 is in the single actuation mode, each time the trigger 26 is pulled, the rebar tying tool 2 performs a rebar tying operation a single time, in which the wire W is used to tie together one set of crossing rebars R. That is, the trigger 26 must be pulled each time one set of crossing rebars R is to be tied together. On the other hand, when the rebar tying tool 2 is in the continuous actuation mode and while in the state in which the trigger 26 is maintained in the pulled state, each time a contact member 46 located at the front end of the main-body housing 4 is pushed by the rebar(s) R, the rebar tying tool 2 performs the rebar tying operation a single time, in which the wire W is used to tie together one set of crossing rebars R. In other words, it is not necessary to pull the trigger 26 each time a set of crossing rebars R is to be tied together, because as long as the trigger 26 remains continuously pulled, successive sets of crossing rebars R will be tied together each time the contact member 46 is pushed in response to being pressed against one set of crossing rebars R (typically, the contact member 46 contacts (is pressed against) only the uppermost rebar R of each set of crossing rebars R). It is noted that a detection switch 48 (see FIG. 2) detects the contact member 46 being pushed and relays this contact information (signal) to a control unit 58 to cause the control unit 58 to execute a rebar tying operation, as will be further discussed below.

The tying-strength increase switch 42 increases a set (preset, user-set) value for the tying strength applied to the wire W tied by the rebar tying tool 2. The tying-strength decrease switch 44 decreases the set (preset, user-set) value for the tying strength applied to the wire W tied by the rebar tying tool 2. More specifically, when the tying-strength increase switch 42 is manipulated (e.g., pressed), the set value for the tying strength applied to the wire W increases by one step, and when the tying-strength decrease switch 44 is manipulated (e.g., pressed), the set value for the tying strength applied to the wire W decreases by one step. The tying strength applied to the wire W serves as a representative, nonlimiting corresponding structure of the (rotational) force (torque) with which the ends of the wire are twisted together.

As shown in FIG. 2, the rebar tying tool 2 further comprises a feed unit 50, a guide unit 52, a cutting unit 54, the twisting unit 56, and the control unit 58.

The feed unit 50 is housed in the feed-motor housing part 22. The feed unit 50 comprises a feed motor 62 and a feed roller 64. The feed motor 62 is, for example, a brushless motor. The rotor of the feed motor 62 is rotated using electric power supplied from the battery pack BP. The feed roller 64 is operably coupled to the feed motor 62 via a reduction gear (not shown). The feed roller 64 serves as a representative, nonlimiting corresponding structure of a feed member. The rotor of the feed roller 64 rotates when the rotor of the feed motor 62 rotates. The feed roller 64 pulls the wire W from the bobbin 32 when rotating in a forward rotational direction (i.e. one of clockwise or counterclockwise), and feeds (reels out) the wire W to a forward-upper side toward the guide unit 52. In addition, the feed roller 64 draws back the wire W toward the bobbin 32 when rotated in a reverse rotational direction (i.e. the other of clockwise or counterclockwise).

The guide unit 52 comprises an upper-side, curl-guide member 68 and a lower-side, curl-guide member 70. The upper-side, curl-guide member 68 and the lower-side, curl-guide member 70 are held on the front end of the guide-member holding part 14. The upper-side, curl-guide member 68 and the lower-side, curl-guide member 70 extend forward in the front-rear direction from the front end of the guide-member holding part 14. At least two rebars R are disposed between the upper-side, curl-guide member 68 and the lower-side, curl-guide member 70 when a rebar tying operation is performed. The wire W fed from the feed roller 64 is first guided to the upper-side, curl-guide member 68, and then passes from rearward to forward through the interior of the upper-side, curl-guide member 68. As the wire W passes through the interior of the upper-side, curl-guide member 68, the upper-side, curl-guide member 68 imparts a downward curl to the wire W. After passing through the upper-side, curl-guide member 68, the wire W is guided to the lower-side, curl-guide member 70 and passes from forward to rearward through the interior of the lower-side, curl-guide member 70. After that, the wire W moves toward the rearward-upper side. Thereby, the wire W is wound (looped) around two or more crossing rebars R.

The cutting unit 54 is housed in the guide-member holding part 14. The cutting unit 54 is disposed downward of the twisting unit 56. The cutting unit 54 comprises a cutter (not shown) that cuts the wire W fed from the feed unit 50 to the guide unit 52. The cutter cuts the wire W by rotating.

The twisting unit 56 is disposed so as to span the guide-member holding part 14 and the twisting-motor housing part 16. The twisting unit 56 comprises a twisting motor 74, a sleeve unit 76, and a grip clamp 78. The twisting motor 74 is housed in the twisting-motor housing part 16. The twisting motor 74 may be, for example, a brushless motor. The rotor of the twisting motor 74 is rotated about central axis AX using electric power supplied from the battery pack BP. Central axis AX extends in, or in parallel with, the front-rear direction.

The sleeve unit 76 and the grip clamp 78 are housed in the guide-member holding part 14. When the rotor of the twisting motor 74 rotates, the sleeve unit 76 moves in the front-rear direction or rotates about central axis AX. The grip clamp 78 is located at a front portion of the twisting unit 56. The grip clamp 78 serves as a representative, nonlimiting corresponding structure of a twisting member. More specifically, when the rotor of the twisting motor 74 rotates in a forward rotational direction (i.e. one of clockwise or counterclockwise), the sleeve unit 76 first moves forward in the front-rear direction and the grip clamp 78 grips both ends of the wire that is wound (looped) around the rebars R. When the rotor of the twisting motor 74 is rotated further in the forward rotational direction from this state, the sleeve unit 76 will now also be rotated in the forward rotational direction and the grip clamp 78 will be rotated integrally with the sleeve unit 76. Thereby, the grip clamp 78 twists together the ends of the wire W. As a result, the rebars R are tied together using the wire W. When the rotor of the twisting motor 74 is then rotated from this state in the reverse rotational direction (i.e. the other of clockwise or counterclockwise), the sleeve unit 76 will also be rotated in the reverse rotational direction and the wire W will be released from the grip clamp 78. When the rotor of the twisting motor 74 is rotated further in the reverse rotational direction, the sleeve unit 76 is moved rearward in the front-rear direction.

The control unit 58 is housed in the control-unit housing part 20. The control unit 58 comprises a control circuit board 82, which comprises an MCU (not shown) and switching elements (not shown), such as power FETs capable of conducting relatively large currents at high voltage using electric power from the battery pack to drive the motors. The control unit 58 is electrically connected to the trigger-detection switch 27, the main-power-supply switch 36, the display part 38, the mode-change switch 40, the tying-strength increase switch 42, the tying-strength decrease switch 44, the detection switch 48, the feed motor 62, the twisting motor 74, and the battery pack BP. In the state in which the rebar tying tool 2 is in the ON state, when (each time) the user pulls the trigger 26 (single actuation mode) or when (each time) the contact member 46 is pushed while the user is continuously pulling (squeezing) the trigger 26 (continuous actuation mode), the control unit 58 drives the feed motor 62 and the twisting motor 74 and executes a tying process, which ties together rebars R using the wire W.

More specifically, the control unit 58 first causes the rotor of the feed motor 62 to rotate in the forward rotational direction to cause the feed roller 64 to rotate in the forward rotational direction. Thereby, the wire W is fed, and is guided by the upper-side, curl-guide member 68 and the lower-side curl-guide member 70, and thereby is wound (looped) around the rebars R. Next, the control unit 58 causes the rotor of the twisting motor 74 to rotate in the forward rotational direction to cause the sleeve unit 76 to move forward in the front-rear direction. Thereby, the grip clamp 78 grips a tip end portion of the wire W. Next, the control unit 58 causes the rotor of the feed motor 62 to rotate in the reverse rotational direction to cause the feed roller 64 to rotate in the reverse rotational direction. As the wire W is drawn back into the feed roller 64, the loop of the wire W reduces in diameter (is tightened), whereby the wire W snugly contacts the rebars R. Next, the control unit 58 causes the rotor of the twisting motor 74 to rotate further in the forward rotational direction to cause the sleeve unit 76 to move farther forward in the front-rear direction. Thereby, the tip end portion and an intermediate portion of the wire W are held by the grip clamp 78 between the upper-side, curl-guide member 68 and the cutting unit 54. Next, the control unit 58 causes the twisting motor 74 to rotate further in the forward rotational direction to cause the sleeve unit 76 to move farther forward in the front-rear direction. The wire W is then cut by the cutting unit 54 owing to the twisting unit 56 manipulating the cutting unit 54. Next, the control unit 58 causes the twisting motor 74 to rotate further in the forward rotational direction to cause the sleeve unit 76 to rotate in the forward rotational direction. The ends of the wire W are twisted together when the grip clamp 78 is rotated about central axis AX in the forward rotational direction in this state. Next, the control unit 58 causes the rotor of the twisting motor 74 to rotate in the reverse rotational direction to cause the sleeve unit 76 to rotate in the reverse rotational direction. Thereby, the wire W is released from the grip clamp 78. Finally, the control unit 58 causes the rotor of the twisting motor 74 to rotate further in the reverse rotational direction to cause the sleeve unit 76 to move rearward in the front-rear direction. Thereby, the twisting unit 56 returns to its initial position.

As shown in FIG. 3, the rebar tying tool 2 comprises a first illumination member 100 and a second illumination member 102. The first illumination member 100 and the second illumination member 102 each emit light. The configuration of the first illumination member 100 and the configuration of the second illumination member 102 are identical or are at least substantially identical. Consequently, the first illumination member 100 and the second illumination member 102 may each be individually referred to below as an illumination member 104. The luminous flux of the light emitted by each illumination member 104 (i.e. the first illumination member 100 or the second illumination member 102) is 1 lumen or more and 10,000 lumens or less. The luminous flux of the light emitted by each illumination member 104 may be 1 lumen or more and 1,500 lumens or less, may be 1 lumen or more and 1,000 lumens or less, may be 3 lumens or more and 500 lumens or less, or may be 5 lumens or more and 300 lumens or less. In addition, the luminous-flux intensity of the light emitted by each illumination member 104, is 70 lux or more and 3,000 lux or less at a location that is 150 mm from the (each) illumination member 104 in a direction of irradiation (e.g., forward in the front-rear direction) of the light. The luminous-flux intensity of the light emitted by the illumination member 104 may be 70 lux or more and 2,500 lux or less, may be 100 lux or more and 2,500 lux or less, or may be 100 lux or more and 2,000 lux or less at a location that is 150 mm from the (each) illumination member 104 in a direction of irradiation of the light.

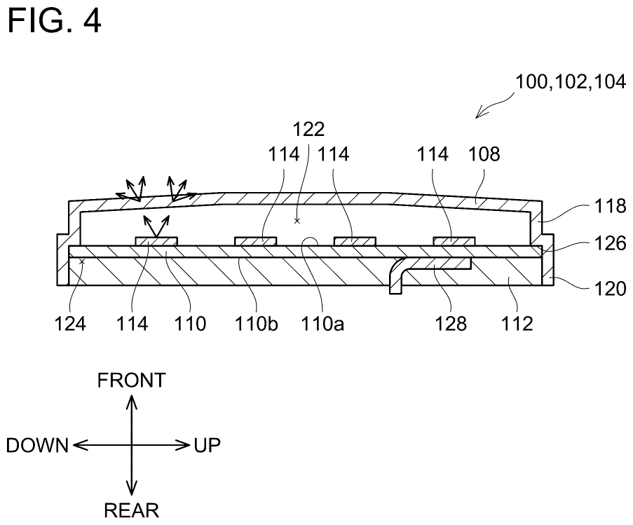

As shown in FIG. 4, each of the first and second illumination members 100, 102 comprises a lens 108, a circuit board 110, a bonding agent 112, and a plurality of chip LEDs 114 (four, in the present working example).

The lens 108 defines the external shape of each of the first and second illumination members 100, 102. The lens 108 is configured to transmit light. It is noted that the directions of the light are depicted by arrow lines in FIG. 4. The lens 108 serves as a representative, nonlimiting corresponding structure of a transmissive part. In addition, the lens 108 of the present working example is also configured to diffuse light. Therefore, the lens 108 also serves as a representative, nonlimiting corresponding structure of a diffusion part. The lens 108 may be composed of an optically transmissive polymer, such as, for example, an acrylic, a polycarbonate, a polyamide, or an acrylonitrile butadiene styrene (ABS). For example, the polymer may be translucent, i.e. made up of components having different indices of refraction so that photons are scattered by the lens 108. However, other types of diffusing or diffracting structures and/or compositions are well within the present teachings.

The lens 108 comprises a first housing part 118 and a second housing part 120. The first housing part 118 has (defines), in its interior, a first housing space 122. The second housing part 120 has (defines), in its interior, a second housing space 124. The second housing part 120 is disposed on the rear side of the first housing part 118. The width of the second housing part 120 in the up-down direction is wider than the width of the first housing part 118 in the up-down direction. Consequently, a step part 126 is formed in the interior of the lens 108 between the first housing part 118 and the second housing part 120.

The circuit board 110 is disposed in the second housing space 124. The circuit board 110 is plate shaped. A first (forward) surface 110a of the circuit board 110 contacts the step part 126 from the rear side. The rebar tying tool 2 further comprises a lead line (conductive wire) 128, which is connected to a second (rearward) surface 110b of the circuit board 110. The second surface 110b is the surface on the side of the circuit board 110 opposite to the first surface 110a in the front-rear direction. As shown in FIG. 2, the lead line 128 passes through the interior of the guide-member holding part 14, the interior of the twisting-motor housing part 16, the interior of the grip part 18, and the interior of the control-unit housing part 20 in that order. Inside of the control-unit housing part 20, the lead line 128 is electrically connected to the control circuit board 82. Thereby, the circuit board 110 (see FIG. 4) is electrically connected to the control circuit board 82.

As shown in FIG. 4, the bonding agent 112 is disposed (filled) in the second housing space 124. The bonding agent 112 contacts the second surface 110b of the circuit board 110. By injecting the bonding agent 112 into the second housing space 124 and hardening the bonding agent 112 in the state in which the first surface 110a of the circuit board 110 is in contact with the step part 126, the circuit board 110 is fixed to the lens 108, and the lead line 128 is rigidly (robustly) fixed to the circuit board 110.

Each of the chip LEDs 114 is a surface-mount device (SMD)-type LED. The plurality of chip LEDs 114 is mounted on the first surface 110a of the circuit board 110. The plurality of chip LEDs 114 is disposed in the first housing space 122. The chip LEDs 114 are actuated (energized, illuminated, turned ON) by the control unit 58 (see FIG. 2). The chip LEDs 114 emit light using electric power from the battery pack BP (see FIG. 1).

After arriving at the lens 108, the light emitted by the chip LEDs 114 passes through the lens 108. The light is diffused by the lens 108 while being transmitted through the lens 108. Thereby, diffused light is emitted by each of the first and second illumination members 100, 102.

As shown in FIG. 3, the first illumination member 100 and the second illumination member 102 are held on the main-body housing 4. More specifically, in the present working example, the first illumination member 100 and the second illumination member 102 are disposed on the guide-member holding part 14 of the main-body housing 4. The first illumination member 100 and the second illumination member 102 are spaced apart in the left-right direction. The location of the first illumination member 100 in the up-down direction and the location of the second illumination member 102 in the up-down direction are identical or at least substantially identical. The first illumination member 100 and the second illumination member 102 face forward and the longitudinal directions (axes) of the first illumination member 100 and the second illumination member 102 extend in parallel or at least substantially in parallel to each other, although a slight inclination within a range of, e.g., up to 5-10° is possible. As shown in FIG. 2, the first illumination member 100 and the second illumination member 102 (see FIG. 3) are disposed upward of the grip part 18, the trigger 26, and the feed-motor housing part 22. The first illumination member 100 and the second illumination member 102 are disposed forward of the trigger 26, the feed unit 50, the cutting unit 54, and the grip clamp 78. When viewing the rebar tying tool 2 from the front in the front-rear direction as shown in FIG. 5, the first illumination member 100 and the second illumination member 102 are disposed downward of the upper-side, curl-guide member 68 and upward of the lower-side, curl-guide member 70. Thus, in the up-down direction, the first illumination member 100 and the second illumination member 102 are disposed between the upper-side, curl-guide member 68 and the lower-side, curl-guide member 70. The center of the first illumination member 100 in the up-down direction and the center of the second illumination member 102 in the up-down direction are disposed upward of central axis AX.

The first illumination member 100 is disposed rightward of the upper-side, curl-guide member 68, the lower-side, curl-guide member 70, the grip clamp 78, and central axis AX. The second illumination member 102 is disposed leftward of the upper-side, curl-guide member 68, the lower-side, curl-guide member 70, the grip clamp 78, and central axis AX. The upper-side, curl-guide member 68, the lower-side, curl-guide member 70, the grip clamp 78, and central axis AX are disposed between the first illumination member 100 and the second illumination member 102 in the left-right direction. Consequently, when two rebars R are disposed between the upper-side, curl-guide member 68 and the lower-side, curl-guide member 70 in the left-right direction during the performance of a rebar tying operation as shown in FIG. 5, portions of two rebars R are disposed between the first illumination member 100 and the second illumination member 102, and in particular, the crossing point of the two rebars R is disposed between the first illumination member 100 and the second illumination member 102.

Still referring to FIG. 5, distance L1 between the first illumination member 100 and the second illumination member 102 in the left-right direction is larger than diameter D1 of the rebars R. Distance L1 is 1.5 times or more and 10 times or less than diameter D1. In addition, distance L1 may be 2 times or more and 5 times or less than diameter D1. Width W1 of the first illumination member 100 in the up-down direction and width W2 of the second illumination member 102 in the up-down direction are each larger than diameter D1 of the rebars R. Width W1 and width W2 are each 1.5 times or more and 10 times or less than diameter D1. In addition, width W1 and width W2 each may be 2 times or more and 5 times or less than diameter D1. Width W1 and width W2 are substantially equal. Width W3 of the first illumination member 100 in the left-right direction and width W4 of the second illumination member 102 in the left-right direction are each larger than diameter D1 of the rebars R. Width W1 is greater than or equal to width W3 and width W2 is greater than or equal to width W4. In a modified example, width W1 may be less than or equal to width W3 and width W2 may be less than or equal to width W4. It is noted that, width W1 and width W2 are each substantially equal to the width of the corresponding lens 108 in the up-down direction, and width W3 and width W4 are each substantially equal to the width of the corresponding lens 108 in the left-right direction.

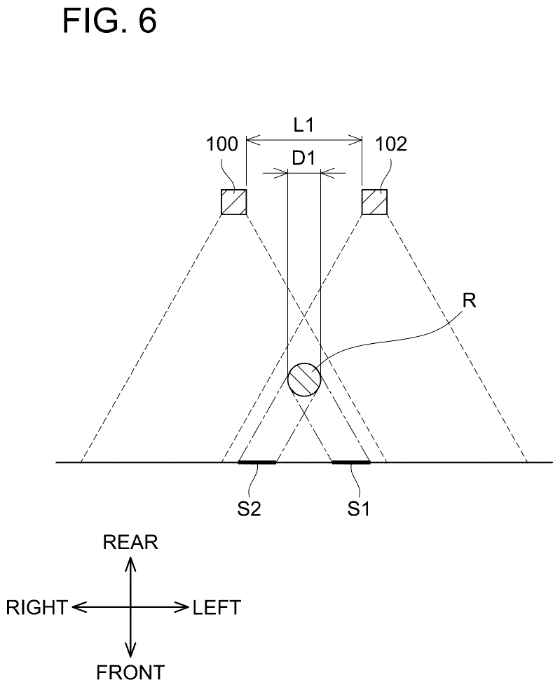

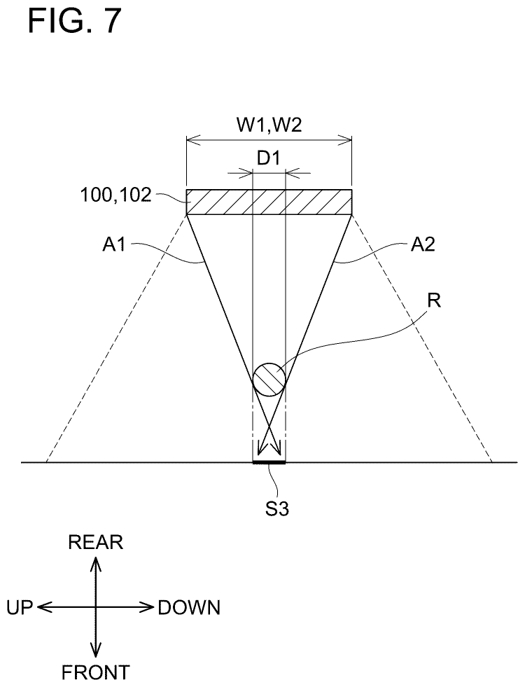

An explanation concerning the advantageous effects of the arrangement and dimensions of the first and second illumination members 100, 102 will now be provided with reference to FIGS. 6 and 7. Here, it is noted that the directions shown in FIGS. 6 and 7 correspond to the directions of the rebar tying tool 2, not to the orientation of the rebars R. More specifically, FIG. 6 shows a cross-sectional plane defined by the front-rear and left-right directions of the rebar tying tool 2; this cross-sectional plane may pass through central axis AX. FIG. 7 shows a cross-sectional plane defined by the front-rear and up-down directions of the rebar tying tool 2. However, the cross-sectional plane of FIG. 7 does not pass through central axis AX, but rather passes through one of the first or second illumination members 100, 102, which are both offset from the central axis AX. Because the cross-sectional views for the corresponding planes passing through the first or second illumination members 100, 102 are essentially identical, regardless of whether the cross-sectional plane passes through the first illumination member 100 or through the second illumination member 102, reference numbers 100 and 102 are indicated in FIG. 7 as representing both the cross-sectional view through the first illumination member 100 and the cross-sectional view through the second illumination member 102. Thus, the illustrations in FIGS. 6 and 7 correspond to any grid of rebars R, regardless of whether the grid of rebars R extends, e.g., in a horizontal plane or a vertical plane. In addition, it is noted that, for the sake of simplicity of illustration, only a first one of the plurality of rebars R forming the grid of rebars R is shown in FIG. 6 and only a second one of the plurality of rebars R forming the grid of rebars R is shown in FIG. 7. In the grid of rebars R, the first one of the rebars R shown in FIG. 6 extends orthogonally to the second one of the rebars R shown in FIG. 7. Furthermore, the outermost ranges of the light emitted by the first illumination member 100 and the second illumination member 102 are depicted in FIG. 6 and FIG. 7 by broken lines. Here, it is to be understood that light is also emitted within (throughout) the entire range between the broken lines for each of the illumination members 100, 102. Referring now to FIG. 6, when the first illumination member 100 and the second illumination member 102 both emit light, the light illuminates, in particular, the first one of the rebars R as shown in FIG. 6. Thus, hypothetically speaking, in an embodiment in which the second illumination member 102 is not provided, a relatively dark (i.e. readily perceptible) shadow S1 could hypothetically be caused (formed) owing to first one of the rebars R blocking a portion of the light emitted by the first illumination member 100 and such shadow S1 would extend in the left-right direction (with reference to the directions of the rebar tying tool 2) on a surface (e.g., a floor (horizontal surface) or a wall (vertical surface)) on the far side of the rebars R. Similarly, hypothetically speaking, in a similar embodiment in which instead the first illumination member 100 is not provided but the second illumination member 102 is provided, a relatively dark (i.e. readily perceptible) shadow S2 could hypothetically be caused (formed) owing to first one of the rebars R blocking a portion of the light emitted by the second illumination member 102 and such shadow S2 would also extend in the left-right direction (with reference to the directions of the rebar tying tool 2) on the surface on the far side of the rebars R. However, in the present working example that has both the first and second illumination members 100, 102, because distance L1 between the first illumination member 100 and the second illumination member 102 is larger than diameter D1 of the rebar(s) R, a portion of the light emitted by the second illumination member 102 illuminates the area of the surface that would otherwise have shadow S1 and a portion of the light emitted by the first illumination member 100 illuminates the area of the surface that would otherwise have shadow S2. Thereby, even if present, shadows S1, S2 tend to be not noticeable due to the oblique, crossing (cross fire) illumination ranges of the first and second illumination members 100, 102. Moreover, even if (barely noticeable) shadows S1, S2 were to move along the surface when the user rotates or otherwise moves the rebar tying tool 2 relative to the grid of rebars R, the user is not likely to be distracted by the (faint) shadows S1, S2 on the surface behind the rebars R.

Similarly, as was mentioned above, FIG. 7 shows the second one of the rebars R, which extends perpendicular to the first one of the rebars R shown in FIG. 6 in the grid of rebars R. The cross-sectional view (plane) of FIG. 7 is perpendicular (orthogonal) to the cross-sectional view (plane) of FIG. 7. Thus, if (contrary to the present working example) the length of the first and second illumination members 100, 102 in the up-down direction of the rebar tying tool 2 were to be less than the above-described dimensions (e.g., the length of the first and second illumination members 100, 102 in the up-down direction, is e.g., less than the diameter of the rebar(s) R), when the rebar R shown in FIG. 7 is illuminated by the light, a relatively dark (i.e. readily perceptible) shadow S3 could hypothetically be caused owing to the second one of the rebars R blocking portions of the light emitted by both the first illumination member 100 and the second illumination member 102 and shadow S3 would extend in the up-down direction (with reference to the directions of the rebar tying tool 2) on the surface on the far side of the rebars R. However, in the present working example, because width W1 of the first illumination member 100 in the up-down direction of the rebar tying tool 2 and width W2 of the second illumination member 102 in the up-down direction of the rebar tying tool 2 are each larger than diameter D1 of the rebar(s) R, a portion of the light emitted by the first illumination member 100 (e.g., the light indicated by arrow lines A1, A2) and a portion of the light emitted by the second illumination member 102 (e.g., the light also indicated by arrow lines A1, A2) illuminate the area behind the second rebar R that otherwise might have shadow S3. Thereby, shadow S3 tends to be not noticeable or is eliminated. In addition, even if (a barely noticeable) shadow S3 on the surface were to move when the user rotates or otherwise moves the rebar tying tool 2 relative to the grid of rebars R, the user is not likely to be distracted by the (faint) shadow S3.

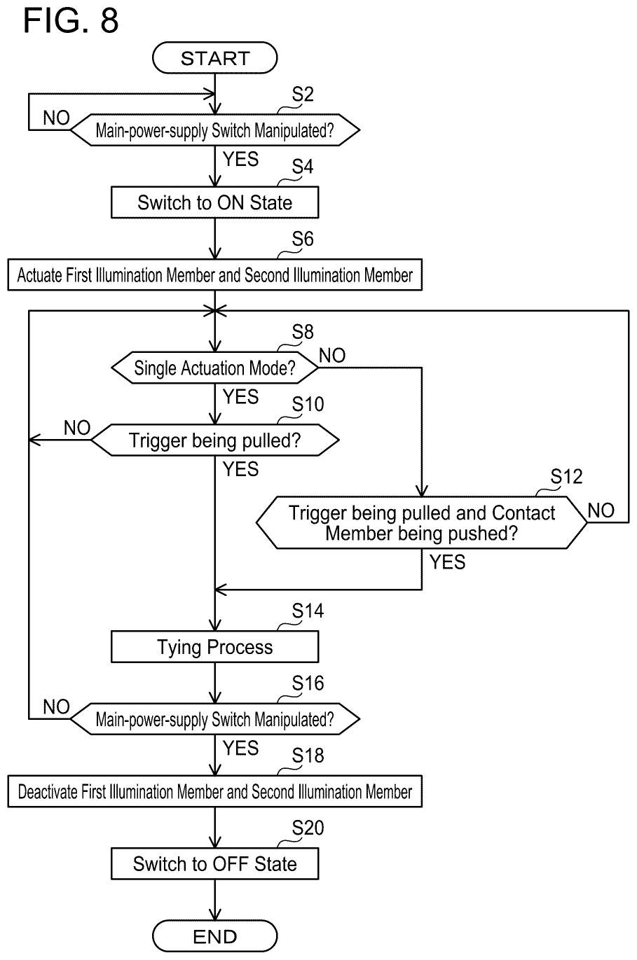

Next, the process shown in FIG. 8, which is executed by the control unit 58, will be explained.

In S2, when the rebar tying tool 2 is in the OFF state, the control unit 58 determines whether the main-power-supply switch (or simply, power switch) 36 has been manipulated (e.g., pressed). The control unit 58 advances to S4 when the main-power-supply switch 36 has been manipulated (YES in S2).

In S4, the control unit 58 switches the rebar tying tool 2 from the OFF state to the ON state.

In S6, the control unit 58 actuates (energizes, illuminates, turns ON) the first illumination member 100 and the second illumination member 102. The first illumination member 100 and the second illumination member 102 emit light that is emitted by the chip LEDs 114. Thereby, the light generated by the first and second illumination members 100, 102 illuminates the rebars R.

In S8, the control unit 58 determines whether the rebar tying tool 2 is in the single actuation mode. The control unit 58 advances to S10 when the rebar tying tool 2 is in the single actuation mode (YES in S8). On the other hand, the control unit 58 advances to S12, when the rebar tying tool 2 is not in the single actuation mode, that is, when the rebar tying tool 2 is in the continuous actuation mode (NO in S8).

In S10, the control unit 58 determines whether the trigger 26 is being pulled based on a detection result of the trigger-detection switch 27. The control unit 58 advances to S14 when the trigger 26 is being pulled (YES in S10). The control unit 58 returns to S8 when the trigger 26 is not being pulled (NO in S10).

In S12, the control unit 58 determines whether the trigger 26 is being pulled, and whether the contact member 46 is being pushed based on the detection result of the trigger-detection switch 27 and the detection result of the detection switch 48. The control unit 58 advances to S14 when the trigger 26 is being pulled and the contact member 46 is being pushed (YES in S12). On the other hand, the control unit 58 returns to S8 when the trigger 26 is not being pulled and/or the contact member 46 is not being pushed (NO in S12).

In S14, the control unit 58 executes the tying process. Thereby, the rebars R are tied together using the wire W.

In S16, the control unit 58 determines whether the main-power-supply switch 36 has been manipulated (e.g., pressed). The control unit 58 advances to S18 when the main-power-supply switch 36 has been manipulated (YES in S16). On the other hand, the control unit 58 returns to S8 when the main-power-supply switch 36 has not been manipulated (NO in S16).

In S18, the control unit 58 deactivates (deenergizes, turns OFF) the first illumination member 100 and the second illumination member 102. Thus, the first illumination member 100 and the second illumination member 102 no longer emit light owing to the chip LEDs 114 stopping light emission.

In S20, the control unit 58 switches the rebar tying tool 2 from the ON state to the OFF state. After that, the control unit 58 ends the process shown in FIG. 8.

### Effects

The rebar tying tool 2 of the present working example comprises: the twisting motor 74, which drives the grip clamp 78 (one representative example that serves as a nonlimiting corresponding structure of a twisting member) that twists the wire W, which has been wound (looped) around the rebars R; the main-body housing 4, which houses the twisting motor 74; and (at least) the first illumination member 100 held on the main-body housing 4, which shines light toward the rebars R.

According to the above-mentioned configuration, when using the rebar tying tool 2 in a dark location, the rebars R are illuminated by the light from (at least) the first illumination member 100. Thereby, the rebars R can be made easier to see.

In addition, the first illumination member 100 comprises the lens 108 (one representative example that serves as a nonlimiting corresponding structure of a transmissive part), through which the light from (generated in) the interior of the first illumination member 100 is transmitted to the exterior of the first illumination member 100. Width W1 of the lens 108 is larger than diameter D1 of the rebars R.

According to the above-mentioned configuration, the width (range) of the light transmitted through the lens 108 is larger than diameter D1 of the rebars R. Thereby, the entirety of the rebars R is illuminated and the rebars R can be made easier to see.

In addition, the rebar tying tool 2 further comprises the upper-side, curl-guide member 68 and the lower-side, curl-guide member 70 (one representative example that serves as a nonlimiting corresponding structure of a guide member), which (are configured to) wind (loop) the wire W around the rebars R. The main-body housing 4 comprises the guide-member holding part 14, which holds the upper-side, curl-guide member 68 and the lower-side, curl-guide member 70. The first illumination member 100 is disposed on the guide-member holding part 14.

According to the above-mentioned configuration, when using the rebar tying tool 2 to tie rebars R, the upper-side, curl-guide member 68 and the lower-side, curl-guide member 70 are disposed proximate to the rebars R. Consequently, (at least) the first illumination member 100 is disposed proximate to the rebars R. Thereby, the rebars R can be made easier to see owing to the light from (at least) the first illumination member 100.

In addition thereto, the rebar tying tool 2 also comprises the second illumination member 102, which is held on the main-body housing 4 and shines light toward the rebars R.

According to the above-mentioned configuration, the rebars R can be made easier to see than in a configuration in which only a single illumination member (e.g., only 100 or 102) is used.

As was noted above, the rebar tying tool 2 of Working Example 1 comprises the upper-side, curl-guide member 68 and the lower-side, curl-guide member 70, which wind (loop) the wire W around the rebars R. Furthermore, the main-body housing 4 comprises the guide-member holding part 14, which holds the upper-side, curl-guide member 68 and the lower-side, curl-guide member 70. In this aspect of Working Example 1, both the first illumination member 100 and the second illumination member 102 are (preferably) disposed on the guide-member holding part 14.

As was mentioned above, when using the rebar tying tool 2 to tie rebars R, the upper-side, curl-guide member 68 and the lower-side, curl-guide member 70 are disposed proximate to the rebars R. Consequently, according to the above-mentioned aspect of Working Example 1, both the first illumination member 100 and the second illumination member 102 are disposed proximate to the rebars R. Thereby, the rebars R can be made easier to see because light is provided from both the first illumination member 100 and the second illumination member 102. Furthermore, the first and second illumination members 100, 102 are preferably dimensioned and arranged (relative to each other and to other components of the rebar tying tool 2) so that the (combined) light from the first and second illumination members 100, 102 is shined on the rebars R without (or with barely) casting a shadow (S1, S2, and/or S3) on the surface (e.g., a wall, a floor, etc.) on the opposite side of the rebars R from the rebar-tying tool 2. Preferably, at least portions of the ranges of illumination respectively emitted by the first and second illumination members 100, 102 cross, e.g., in a cross fire manner, thereby ensuring that areas of the wall directly behind the rebars R can be sufficiently illuminated to avoid, or make nearly imperceptible, shadows (S1, S2, or S3) on the surface behind the rebars R, which (if present) could distract the user while working in a dark location. Preferable dimensions and arrangements for this aspect of the present teachings are described above and below.

In addition, the rotor of the twisting motor 74 rotates about central axis AX, which extends in, or in parallel with, the front-rear direction. When viewing the rebar tying tool 2 in the front-rear direction, the upper-side, curl-guide member 68 and the lower-side, curl-guide member 70, as well as at least the rotor of the twisting motor 74, are disposed between the first illumination member 100 and the second illumination member 102 in the left-right direction, which is orthogonal to the front-rear direction.

According to the above-mentioned configuration, when using the rebar tying tool 2 to tie rebars R, both the light from the first illumination member 100 and the light from the second illumination member 102 illuminate the rebars R. Therefore, when the rebars R are illuminated by the light from both the first illumination member 100 and the second illumination member 102 that have been arranged in the above-mentioned manner, it is possible to avoid, or make nearly imperceptible, shadows S1, S2 on the surface on the far side of the rebars R. Accordingly, shadows S1, S2, even if present on the surface on the far side of the rebars R, can be made to be not noticeable. In addition, even if such shadows S1, S2 were to move each time the user rotates or otherwise moves the rebar tying tool 2 relative to the rebars R, the user is unlikely to be distracted by the (faint) shadows S1, S2.

In addition, when viewing the rebar tying tool 2 in the front-rear direction, the grip clamp 78 is disposed between the first illumination member 100 and the second illumination member 102 in the left-right direction, which is orthogonal to the front-rear direction.

According to the above-mentioned configuration, shadows S1, S2, which might form on the surface on the far side of the rebars R, can be made to be not noticeable when tying the rebars R.

In addition, distance L1 between the first illumination member 100 and the second illumination member 102 is larger than diameter D1 of the rebars R.

According to the above-mentioned configuration, shadows S1, S2, which (even if present) appear on the surface on the far side of the rebars R, can be made to be even less noticeable when tying the rebars R due to the crossfire manner of illumination achievable by the above-mentioned dimensions and arrangement of the first and second illumination members 100, 102.

In addition, the luminous flux of the light emitted by each one of the first illumination member 100 and the second illumination member 102 is 1 lumen or more and 10,000 lumens or less.

According to the above-mentioned configuration, the rebars R can be made easier to see owing to the light from the first illumination member 100 and/or the second illumination member 102.

In addition, the luminous-flux intensity of the light emitted by each one of the first illumination member 100 and the second illumination member 102 is 70 lux or more and 3,000 lux or less at a location of 150 mm from the first illumination member 100 and/or from the second illumination member 102 in the direction of the irradiation of the light.

According to the above-mentioned configuration, the rebars R can be made easier to see owing to the light from the first illumination member 100 and/or the second illumination member 102.

In addition, the first illumination member 100 and/or the second illumination member 102 comprises the chip LEDs 114 (one representative example that serves as a nonlimiting corresponding structure of a light-emitting part), which emit light, and the lens 108 (one representative example that serves as a nonlimiting corresponding structure of a diffusion part), which diffuses the light emitted by the chip LEDs 114.

According to the above-mentioned configuration, the irradiation range of the light from the first illumination member 100 and/or the second illumination member 102 can be made larger than a configuration in which the first illumination member 100 and/or the second illumination member 102 does not comprise the (diffusing) lens 108.

In addition, the rebar tying tool 2 further comprises the control unit 58, which drives (controls, energizes) the twisting motor 74, and the lead line (wire) 128, which electrically connects the first illumination member 100 and/or the second illumination member 102 with the control unit 58. The main-body housing 4 comprises the grip part 18, which is (configured to be) gripped by the user when the user is using the rebar tying tool 2. The lead line 128 passes through the interior of the grip part 18.

According to the above-mentioned configuration, the space inside the grip part 18 can be utilized effectively.

In addition, the control unit 58 is capable of actuating (or is configured or programmed to actuate) the first illumination member 100 and driving or controlling (or is configured to electronically drive or control) the twisting motor 74 and executes (or is configured to execute) the tying process that ties the wire W around the rebars R. The control unit 58 causes (or is configured or programmed to actuate, illuminate or turn ON) the first illumination member 100 and/or the second illumination member 102 to emit light prior to executing the tying process.

According to the above-mentioned configuration, the rebars R can be made easier to see when tying rebars R.

A tying method used with the present Working Example 1 involves tying together two or more rebars R using the wire W. The tying method also comprises shining light emitted from a rebar tying tool toward the rebars R and (preferably subsequently thereto) twisting the wire W, which has been wound (looped) around the rebars R, while shining (or continuing to shine) the light on the rebars R.

According to the above-mentioned configuration, the rebars R can be made easier to see when tying rebars R in a dark location.

The present Working Example also involves a method of using the rebar tying tool 2 to tie together two or more rebars R using the wire W. In particular, the rebar tying tool 2 comprises: the twisting motor 74, which drives (or is configured to (mechanically) drive) the grip clamp 78 (one representative example that serves as a nonlimiting corresponding structure of a twisting member) that twists the wire W that is wounded around the rebars R; the trigger 26, which is manipulated (pressable) by the user to actuate, in particular, the twisting motor 74; the first illumination member 100, which shines light toward the rebars R; and the control unit 58 (one representative example that serves as a nonlimiting corresponding structure of an actuating part), which actuates (or is configured to actuate, energize, illuminate, turn ON) the first illumination member 100 and/or the second illumination member 102. The method of use comprises the control unit 58 actuating (energizing, illuminating, turning ON) the first illumination member 100 and/or the second illumination member 102 and (preferably thereafter) driving (energizing) the twisting motor 74 in response to manipulation of the trigger 26 by the user (optionally while continuing to actuate, energize, illuminate, etc., the first illumination member 100 and/or the second illumination member 102 during the twisting operation).

According to the above-mentioned configuration, the rebars R are illuminated by the light from the first illumination member 100 and/or the second illumination member 102. Thereby, the rebars R can be made easier to see when tying rebars R in a dark location.

### Working Example 2

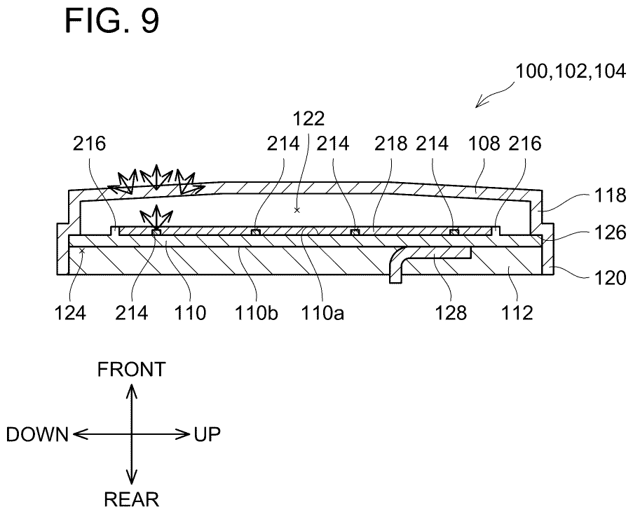

Points in Working Example 2 that differ from Working Example 1 will now be explained. As shown in FIG. 9, each of the first and second illumination members 100, 102 comprises a plurality of chip on board (“COB”) devices 214 (four, in the present working example) instead of the plurality of chip LEDs 114. More specifically, each of the COB devices 214 is a chip-on-board LED. The COB devices 214 are mounted on the first surface 110a of the circuit board 110. The COB devices 214 emit light using electric power from the battery pack BP (see FIG. 1). The COB devices 214 serve as a (another) representative, non-limiting corresponding structure of a light-emitting part.

The illumination member 104 further comprises a rib (ridge, wall) 216 and a fluorescent agent 218. The rib 216 protrudes from the first surface 110a of the circuit board 110. The rib 216 is continuous (without breaks) in contour and thus forms an enclosure (a well) that surrounds (encompasses) all of the COB devices 214.

The fluorescent agent 218 is disposed (placed) in (or deposited into) the space surrounded by the rib 216. Thus, the COB devices 214 are disposed (embedded) in the interior of (or at least underneath) the fluorescent agent 218. The fluorescent agent 218 functions to diffuse the light emitted by the COB devices 214; i.e. light from the COB devices 214 is absorbed by the fluorescent agent 218 and then emitted in a more diffuse or scattered manner than the light from the COB devices 214. The fluorescent agent 218 serves as a (another) representative, nonlimiting corresponding structure of a diffusion part. The light diffused by the fluorescent agent 218 may optionally be further diffused by the lens 108 while being transmitted through the lens 108, although the lens 108 could, in principle, be transparent in a modification of the present Working Example 2 in embodiments in which the fluorescent agent 218 is sufficiently diffusing to achieve the object of diffusing the light from the light source to minimize or even eliminate shadows (S1, S2, S3) on the wall or floor behind the rebars R.

### Working Example 3

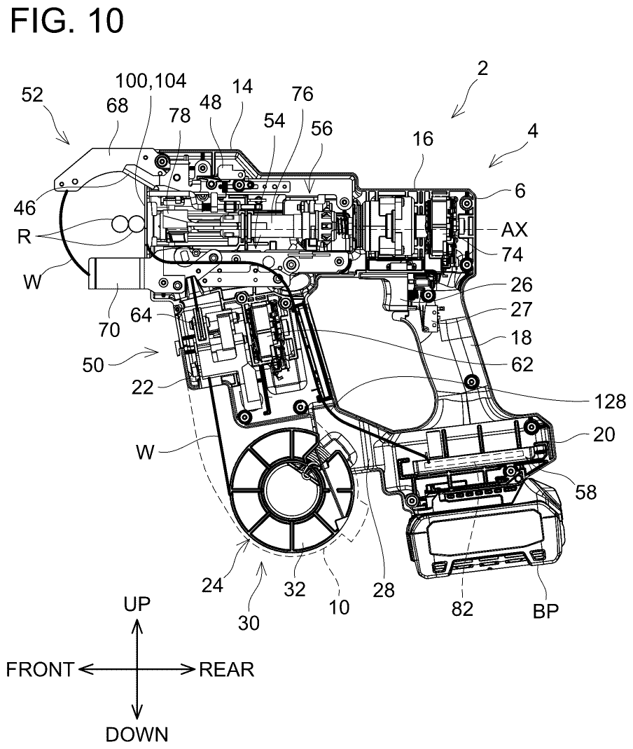

Points in Working Example 3 that differ from Working Example 1 will now be explained. As shown in FIG. 10, the lead line (wire) 128 passes through the interior of the guide-member holding part 14, the interior of the feed-motor housing part 22, the interior of the reel-housing part 24, the interior of the connecting passage 28, and the interior of the control-unit housing part 20, in that order. Inside of the control-unit housing part 20, the lead line 128 is connected to the control circuit board 82.

### Effects

In the present working example, the rebar tying tool 2 comprises, in particular: the feed motor 62, which drives (is configured to (mechanically) drive) the feed roller 64 (one representative example that serves as a nonlimiting corresponding structure of a feed member) that feeds the wire W; the control unit 58, which drives (electronically drives, controls, or energizes) the twisting motor 74 and the feed motor 62; and the lead line (wire) 128, which electrically connects the first illumination member 100 with the control unit 58. The main-body housing 4 comprises, in particular, the feed-motor housing part 22, which houses the feed motor 62. The lead line 128 passes through the interior of the feed-motor housing part 22.

According to the above-mentioned configuration, the space inside the feed-motor housing part 22 can be utilized effectively.

### Working Example 4

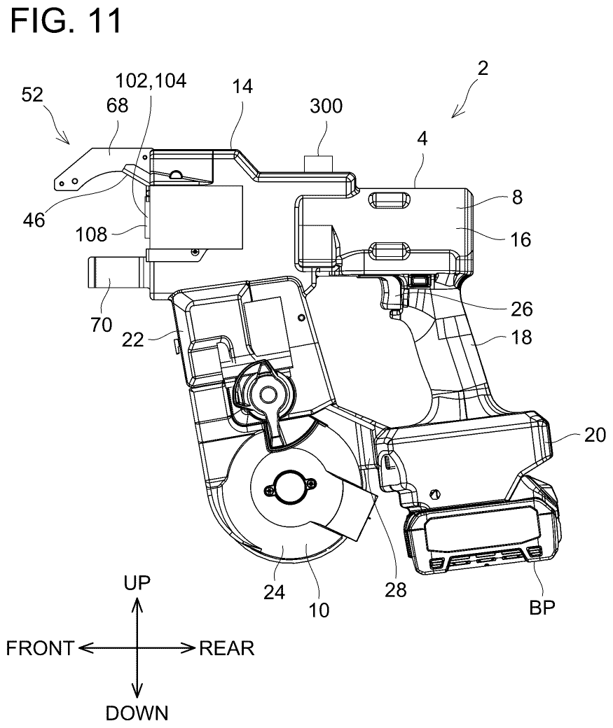

Points in Working Example 4 that differ from Working Example 1 will now be explained. As shown in FIG. 11, the rebar tying tool 2 comprises an actuating switch 300. The actuating switch 300 is disposed on an upper surface of the guide-member holding part 14. The actuating switch 300 is configured to be manipulated (e.g., pressed, slid, toggled, etc.) by the user, which switches the rebar tying tool 2 between the illumination ON state and the illumination OFF state. When the rebar tying tool 2 is in the illumination ON state, the control unit 58 (see FIG. 2) actuates (energizes, illuminates, turns ON) the first illumination member 100 and the second illumination member 102 (see FIG. 5). Thereby, the first illumination member 100 and the second illumination member 102 both emit light. When the rebar tying tool 2 is in the illumination OFF state, the control unit 58 deactivates (turns OFF) the first illumination member 100 and the second illumination member 102, whereby the first illumination member 100 and the second illumination member 102 no longer emit light.

When tying rebars R using the wire W, first, the user manipulates (e.g., presses) the main-power-supply switch 36 (see FIG. 1) to switch the rebar tying tool 2 from the OFF state, in which the rebar tying tool 2 is non-operatable, to the ON state, in which the rebar tying tool 2 is operatable. At this time, the rebar tying tool 2 is in an illumination OFF state. Next, the user manipulates (e.g., presses) the actuating switch 300 to switch the rebar tying tool 2 from the illumination OFF state to the illumination ON state. Thereby, the first illumination member 100 and the second illumination member 102 emit light. Consequently, the rebars R are illuminated by the (combined) light. Next, the user pulls the trigger 26, whereby the control unit 58 executes the above-described tying process such that the rebar tying tool 2 ties together rebars R.

The actuating switch 300 is one representative example that serves as a nonlimiting corresponding structure of an actuating part. Here, it is noted that the actuating switch 300 may be implemented, e.g., as a button (push) switch, a slide switch, a toggle switch, etc.

### Working Example 5

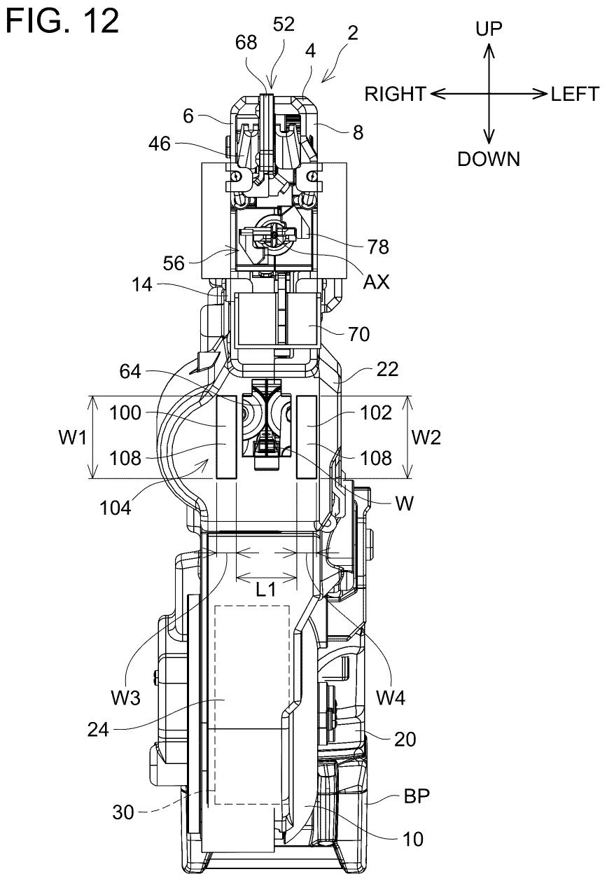

Points in Working Example 5 that differ from Working Example 1 will now be explained. As shown in FIG. 12, the first illumination member 100 and the second illumination member 102 are disposed on a front surface of the feed-motor housing part 22. The first illumination member 100 and the second illumination member 102 are spaced apart in the left-right direction. The first illumination member 100 and the second illumination member 102 face forward.

The first illumination member 100 and the second illumination member 102 are disposed downward of the lower-side, curl-guide member 70, and upward of the reel 30 and the battery pack BP. When viewing the rebar tying tool 2 rearward in the front-rear direction, the first illumination member 100 and the second illumination member 102 are disposed near the feed roller 64. The first illumination member 100 is disposed rightward of the upper-side, curl-guide member 68, the lower-side, curl-guide member 70, the grip clamp 78, central axis AX, and the wire W that is on the feed roller 64. The second illumination member 102 is disposed leftward of the upper-side, curl-guide member 68, the center of the lower-side, curl-guide member 70 in the left-right direction, the center of the grip clamp 78 in the left-right direction, central axis AX, and the wire W that is on the feed roller 64. Distance L1 between the first illumination member 100 and the second illumination member 102 in the left-right direction is larger than diameter D1 (see FIG. 5) of the rebars R.

### Working Example 6

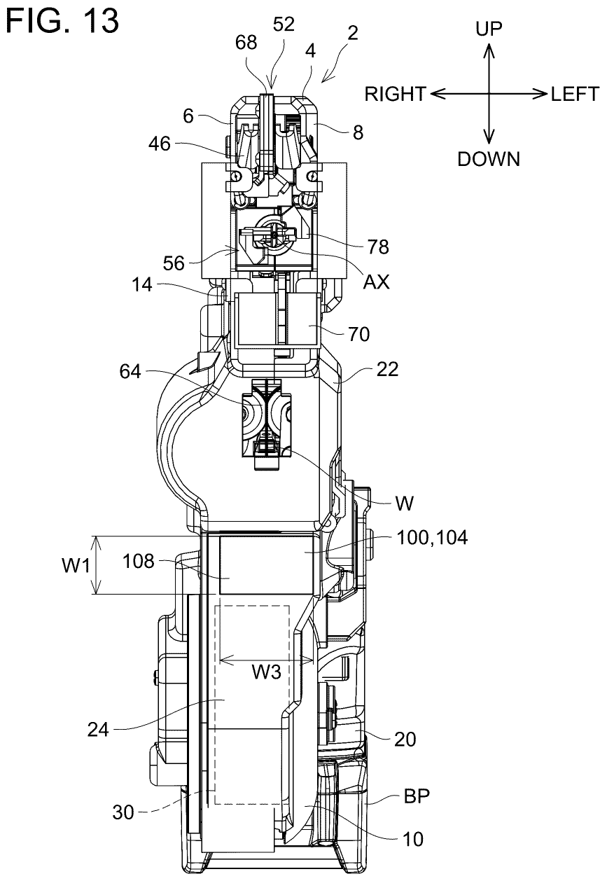

Points in Working Example 6 that differ from Working Example 1 will now be explained. As shown in FIG. 13, the rebar tying tool 2 comprises the first illumination member 100 but does not comprise the second illumination member 102 of Working Example 1. The first illumination member 100 is disposed on a front surface of the reel-housing part 24. The first illumination member 100 faces forward.

The first illumination member 100 is disposed downward of the feed roller 64, and upward of the reel 30 and the battery pack BP. The right end of the first illumination member 100 is disposed rightward of the upper-side, curl-guide member 68, the lower-side, curl-guide member 70, the grip clamp 78, and central axis AX. The left end of the first illumination member 100 is disposed leftward of the upper-side, curl-guide member 68, the center of the lower-side, curl-guide member 70 in the left-right direction, the grip clamp 78, and central axis AX.

Width W1 of the first illumination member 100 in the up-down direction is larger than diameter D1 (see FIG. 5) of the rebars R. Width W1 is 1.5 times or more and 10 times or less than diameter D1. Width W1 may be 2 times or more and 5 times or less than diameter D1. Width W3 of the first illumination member 100 in the left-right direction is larger than diameter D1 of the rebars R. Width W3 is 1.5 times or more and 10 times or less than diameter D1. Width W3 may be 2 times or more and 5 times or less than diameter D1. Width W3 is greater than or equal to width W1. In a modified example, width W3 may be less than or equal to width W1.

### Working Example 7

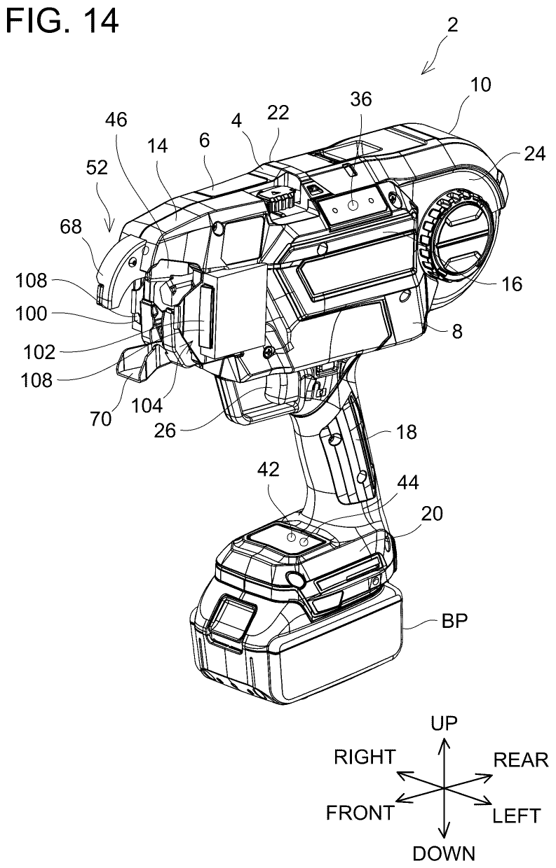

Points in Working Example 7 that differ from Working Example 1 will now be explained with reference to FIGS. 14-16. As illustrated in FIG. 14, the shape of the main-body housing 4 in Working Example 7 differs from the shape of the main-body housing 4 in Working Example 1.

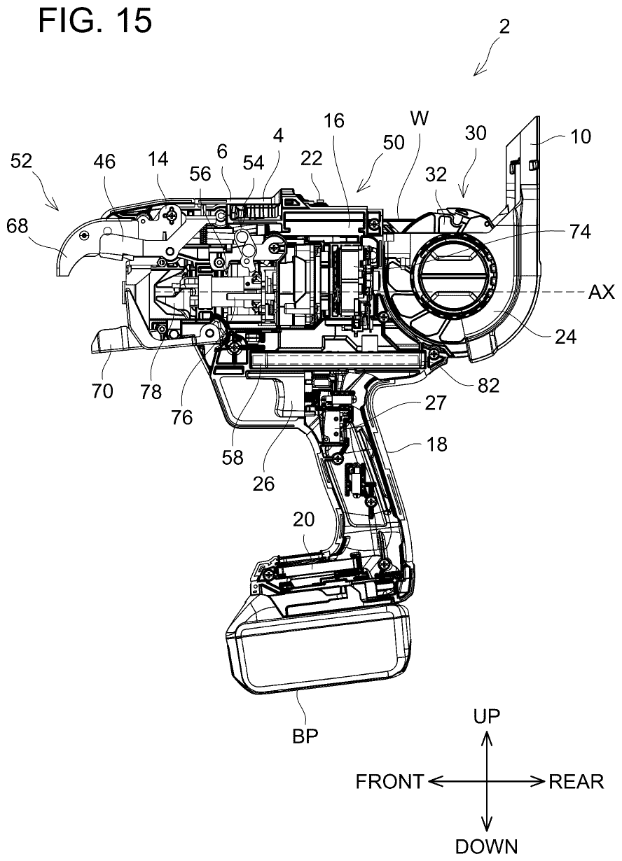

As shown in FIG. 15, the twisting-motor housing part 16 is disposed on the rear side of the guide-member holding part 14. It is noted that in FIG. 15, the reel cover 10 is open. The control unit 58 is housed in the twisting-motor housing part 16. In addition, the cutting unit 54 is disposed upward of the twisting unit 56 in the interior of the twisting-motor housing part 16. The grip part 18 is disposed on the lower side of the twisting-motor housing part 16. The control-unit housing part 20 is disposed on the lower side of the grip part 18. The battery pack BP is mounted on the lower end of the control-unit housing part 20 in a detachable manner. The feed-motor housing part 22 is disposed on an upper side of the grip part 18 at the right side of the twisting-motor housing part 16. The reel-housing part 24 is disposed upward of the grip part 18 and rearward of the twisting-motor housing part 16 and the feed-motor housing part 22. Consequently, the reel 30 is disposed upward of the grip part 18 and rearward of the twisting-motor housing part 16 and the feed-motor housing part 22. The feed unit 50 forwardly feeds the wire W pulled from the reel 30.

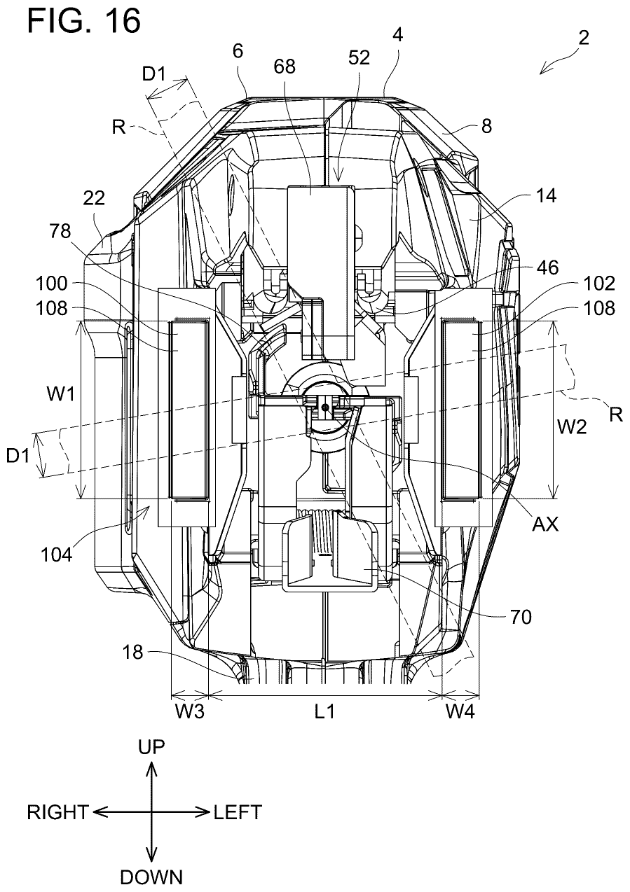

As shown in FIG. 14, the first illumination member 100 and the second illumination member 102 are disposed on the guide-member holding part 14. As shown in FIG. 16, the first illumination member 100 and the second illumination member 102 are spaced apart in the left-right direction. The location of the first illumination member 100 in the up-down direction and the location of the second illumination member 102 in the up-down direction are identical or at least substantially identical. The first illumination member 100 and the second illumination member 102 face forward. The first illumination member 100 and the second illumination member 102 are disposed upward of the grip part 18. The first illumination member 100 and the second illumination member 102 are disposed upward of the lower end of the lower-side, curl-guide member 70 and downward of the upper end of the upper-side, curl-guide member 68.

The first illumination member 100 is disposed rightward of the upper-side, curl-guide member 68, the lower-side, curl-guide member 70, the grip clamp 78, and central axis AX. The second illumination member 102 is disposed leftward of the upper-side, curl-guide member 68, the lower-side, curl-guide member 70, the grip clamp 78, and central axis AX. Thus, the upper-side, curl-guide member 68, the lower-side, curl-guide member 70, the grip clamp 78, and central axis AX are disposed between the first illumination member 100 and the second illumination member 102 in the left-right direction. Consequently, when rebars R are disposed between the upper-side, curl-guide member 68 and the lower-side, curl-guide member 70 during the performance of a rebar tying operation, a portion of each of the rebars R is disposed between the first illumination member 100 and the second illumination member 102, and the crossing point of the two rebars R is also disposed between the first illumination member 100 and the second illumination member 102.

As shown in FIG. 16, distance L1 between the first illumination member 100 and the second illumination member 102 in the left-right direction is larger than diameter D1 of the rebars R. Distance L1 is 1.5 times or more and 10 times or less than diameter D1. In addition, distance L1 may be 2 times or more and 5 times or less than diameter D1. Width W1 of the first illumination member 100 in the up-down direction and width W2 of the second illumination member 102 in the up-down direction are each larger than diameter D1 of the rebars R. Width W1 and width W2 are each 1.5 times or more and 10 times or less than diameter D1. In addition, width W1 and width W2 each may be 2 times or more and 5 times or less than diameter D1. Width W1 and width W2 are equal or at least substantially equal. Width W3 of the first illumination member 100 in the left-right direction and width W4 of the second illumination member 102 in the left-right direction each is smaller than diameter D1 of the rebars R.

### Working Example 8

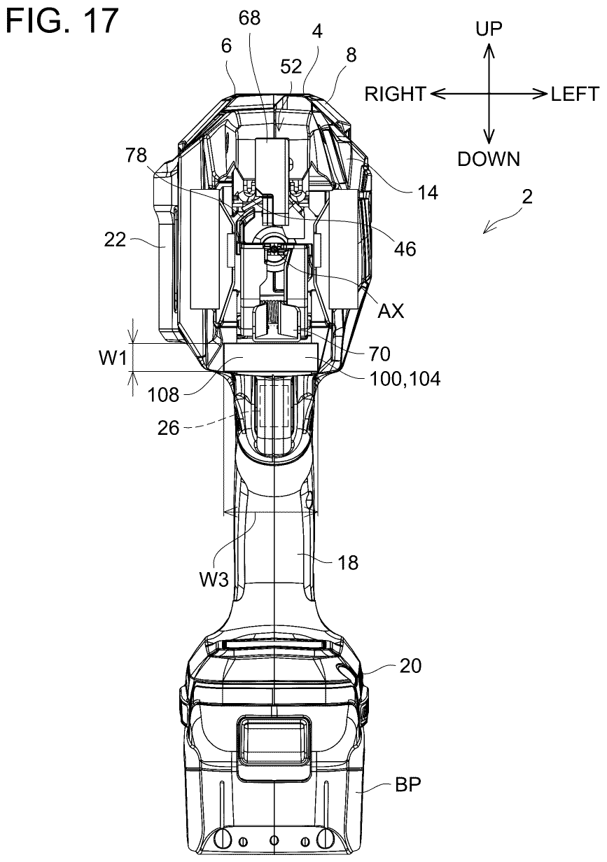

Points in Working Example 8 that differ from Working Example 7 will now be explained. As shown in FIG. 17, the rebar tying tool 2 comprises the first illumination member 100 but does not comprise the second illumination member 102 of Working Example 7. The first illumination member 100 is disposed on the guide-member holding part 14. The first illumination member 100 is disposed downward of the lower-side, curl-guide member 70. The first illumination member 100 faces forward.

The first illumination member 100 is disposed downward of the lower-side, curl-guide member 70 and disposed upward of the grip part 18 and the trigger 26. The right end of the first illumination member 100 is disposed rightward of the right-side surface of the grip part 18, the upper-side, curl-guide member 68, the lower-side, curl-guide member 70, the grip clamp 78, and central axis AX. The left end of the first illumination member 100 is disposed leftward of the left-side surface of the grip part 18, the upper-side, curl-guide member 68, the lower-side, curl-guide member 70, the grip clamp 78, and central axis AX.

Width W1 of the first illumination member 100 in the up-down direction is larger than diameter D1 (see FIG. 16) of the rebars R. Width W1 is 1.5 times or more and 10 times or less than diameter D1. Width W3 of the first illumination member 100 in the left-right direction is also larger than diameter D1 of the rebars R. Width W3 is 1.5 times or more and 10 times or less than diameter D1. Width W3 may be 2 times or more and 5 times or less than diameter D1. Width W3 is greater than or equal to width W1. In a modified example, width W3 may be less than or equal to width W1.

### Working Example 9

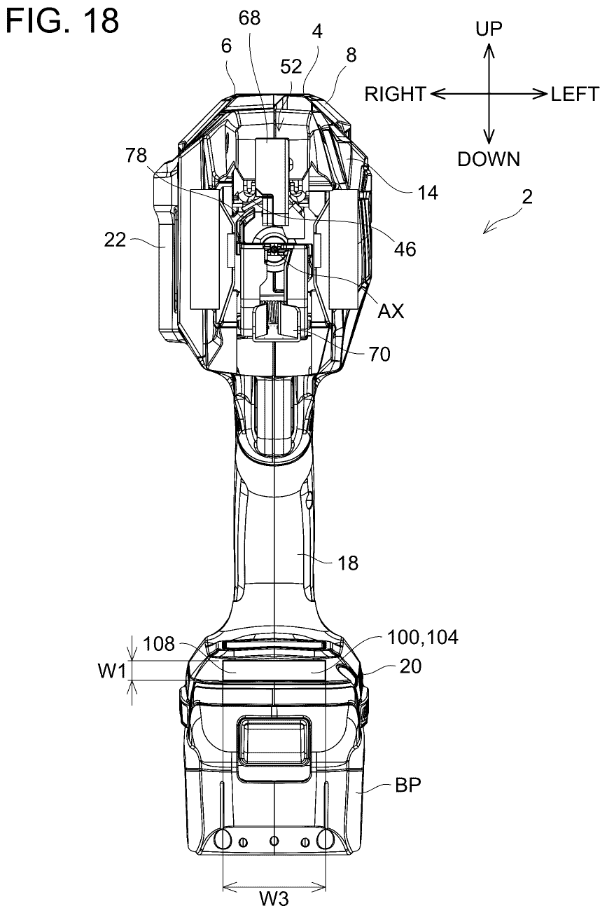

Points in Working Example 9 that differ from Working Example 7 will now be explained. As shown in FIG. 18, the rebar tying tool 2 comprises the first illumination member 100 but does not comprise the second illumination member 102 of Working Example 7. The first illumination member 100 is disposed on a front-upper surface of the control-unit housing part 20. The first illumination member 100 faces forward and upward.

The first illumination member 100 is disposed upward of the battery pack BP and downward of the lower-side, curl-guide member 70 and the grip part 18. The right end of the first illumination member 100 is disposed rightward of the right-side surface of the grip part 18, the upper-side, curl-guide member 68, the lower-side, curl-guide member 70, the grip clamp 78, and central axis AX. The left end of the first illumination member 100 is disposed leftward of the left-side surface of the grip part 18, the upper-side, curl-guide member 68, the lower-side, curl-guide member 70, the grip clamp 78, and central axis AX.

Width W1 of the first illumination member 100 in the up-down direction is larger than diameter D1 (see FIG. 18) of the rebars R. Width W3 of the first illumination member 100 in the left-right direction is also larger than diameter D1 of the rebars R. Width W3 is 1.5 times or more and 10 times or less than diameter D1. Width W3 may be 2 times or more and 5 times or less than diameter D1. Width W3 is greater than or equal to width W1. In a modified example, width W3 may be less than or equal to width W1.

### Working Example 10

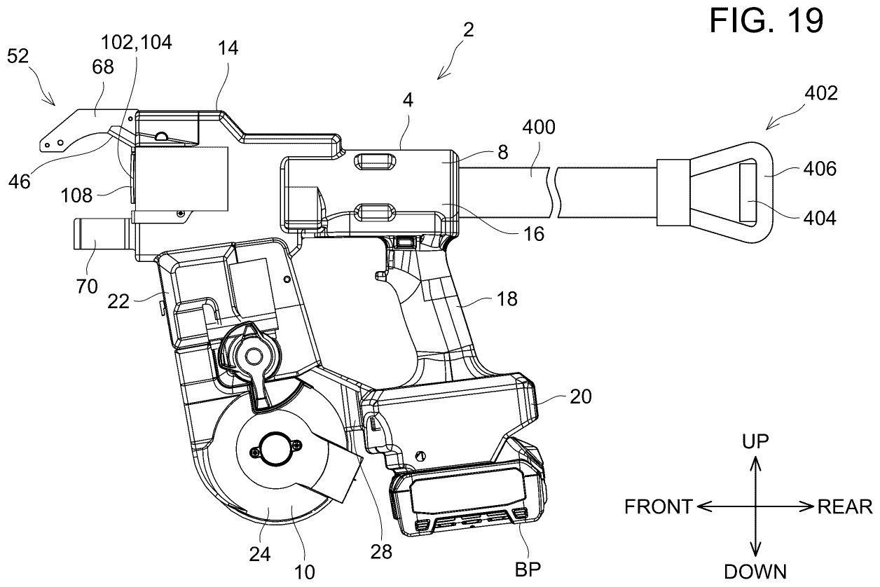

Points in Working Example 10 that differ from Working Example 1 will now be explained. As shown in FIG. 19, the rebar tying tool 2 further comprises an arm 400, a handle 402, and a trigger 404. The arm 400 has an elongated and narrow shape in the front-rear direction. The arm 400 extends rearward from the rear end of the main-body housing 4.

The handle 402 is fixed to the rear end of the arm 400. The handle 402 has a grip part 406. The grip part 406 is (configured to be) gripped when work is performed using the rebar tying tool 2.

The trigger 404 is mounted on the front surface of the grip part 406 in a pullable (slidable) manner. When the user is standing while gripping the handle and pulls the trigger 404 with the rebar tying tool 2 in the ON state, the control unit 58 (see FIG. 2) executes the tying process. Thereby, the user can tie the rebars R without bending down.

The first illumination member 100 (see FIG. 1) and the second illumination member 102 are disposed on the guide-member holding part 14. The arrangement of the first illumination member 100 and the arrangement of the second illumination member 102 are identical or at least substantially identical to the arrangement of the first illumination member 100 and the arrangement of the second illumination member 102, respectively, of Working Example 1. In a modified example, the first illumination member 100 and the second illumination member 102 may be disposed on the feed-motor housing part 22, or may be disposed on the reel-housing part 24.

### Modified Examples

In embodiments of the present teachings, the rebar tying tool 2 may comprise only one illumination member 100 or 102 or may comprise three or more illumination members 100, 102, 104.

In addition or in the alternative, the illumination member 100, 102, 104 is not limited to a configuration in which light is emitted by surface emission, as in the above-described working examples, and they may instead have a configuration in which light is emitted by point emission.

In addition or in the alternative, one or more of widths W1, W2, W3, W4 of the illumination member 100, 102, 104 may be less than or equal to diameter D1 of the rebars R.

In addition or in the alternative, the rebar tying tool 2 may be, for example, an autonomous-type rebar tying tool that moves along the rebars R.

Although some aspects of the present disclosure have been described in the context of a device, it is to be understood that these aspects also represent a description of a corresponding method, so that each block or component of a device, such as the control unit 58, is also understood as a corresponding method step or as a feature of a method step. In an analogous manner, aspects which have been described in the context of or as a method step also represent a description of a corresponding block or detail or feature of a corresponding device, such as the control unit.

Depending on certain implementation requirements, exemplary embodiments of the control unit of the present disclosure may be implemented in hardware and/or in software. The implementation can be configured using a digital storage medium, for example one or more of a ROM, a PROM, an EPROM, an EEPROM or a flash memory, on which electronically readable control signals (program code) are stored, which interact or can interact with a programmable hardware component such that the respective method is performed.

A programmable hardware component can be formed by a processor, a computer processor (CPU=central processing unit), an application-specific integrated circuit (ASIC), an integrated circuit (IC), a computer, a system-on-a-chip (SOC), a programmable logic element, or a field programmable gate array (FGPA) including a microprocessor.

The digital storage medium can therefore be machine-or computer readable. Some exemplary embodiments thus comprise a data carrier or non-transient computer readable medium which includes electronically readable control signals which are capable of interacting with a programmable computer system or a programmable hardware component such that one of the methods described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control unit, are implemented as a program, firmware, computer program, or computer program product including a program, or as data, wherein the program code or the data is operative to perform one of the methods if the program runs on a processor or a programmable hardware component. The program code or the data can for example also be stored on a machine-readable carrier or data carrier. The program code or the data can be, among other things, source code, machine code, bytecode or another intermediate code.

A program according to an exemplary embodiment can implement one of the methods during its performing, for example, such that the program reads storage locations or writes one or more data elements into these storage locations, wherein switching operations or other operations are induced in transistor structures, in amplifier structures, or in other electrical, optical, magnetic components, or components based on another functional principle. Correspondingly, data, values, sensor values, or other program information can be captured, determined, or measured by reading a storage location. By reading one or more storage locations, a program can therefore capture, determine or measure sizes, values, variable, and other information, as well as cause, induce, or perform an action by writing in one or more storage locations, as well as control other apparatuses, machines, and components.

Therefore, although some aspects of the control unit have been identified as “parts” or “steps”, it is understood that such parts or steps need not be physically separate or distinct electrical components, but rather may be different blocks of program code that are executed by the same hardware component, e.g., one or more microprocessors.

### EXPLANATION OF THE REFERENCE NUMBERS

2 Rebar tying tool
4 Main-body housing
14 Guide-member holding part
16 Twisting-motor housing part
18 Grip part
20 Control-unit housing part
22 Feed-motor housing part
24 Reel-housing part
26 Trigger
58 Control unit
62 Feed motor
64 Feed roller
68 Upper-side, curl-guide member
70 Lower-side, curl-guide member
74 Twisting motor
76 Sleeve unit
78 Grip clamp
100 First illumination member
102 Second illumination member
104 Illumination member
108 Lens
114 Chip LED
128 Lead line
214 COB device
218 Fluorescent agent
300 Actuating switch
AX Central axis
D1 Diameter
L1 Distance
R Rebars
S1, S2, S3 Shadows
W Wire
W1, W2, W3, W4 Widths

1. A rebar tying tool comprising:
a twisting motor configured to drive a twisting member that twists a wire, which is wound around two or more rebars;
a main-body housing, which houses the twisting motor; and
a first illumination member, which is held on the main-body housing and is configured to shine light toward the two or more rebars.

2. The rebar tying tool according to claim 1, wherein:
the first illumination member comprises a transmissive part, through which the light is transmitted from the interior of the first illumination member to the exterior of the first illumination member; and
a longest dimension of the transmissive part is larger than the diameter(s) of the two or more rebars.

3. The rebar tying tool according to claim 1, further comprising:
a guide member configured to wind the wire around the rebar;
wherein:
the main-body housing comprises a guide-member holding part that holds the guide member; and
the first illumination member is disposed on the guide-member holding part.

4. The rebar tying tool according to claim 1, further comprising:
a second illumination member, which is held on the main-body housing and is configured to also shine light toward the rebars.

5. The rebar tying tool according to claim 4, further comprising:
a guide member configured to wind the wire around the rebar;
wherein:
the main-body housing comprises a guide-member holding part that holds the guide member; and
the first illumination member and the second illumination member are both disposed on the guide-member holding part.

6. The rebar tying tool according to claim 5, wherein:
a rotor of the twisting motor is rotatable about a central axis which extends in, or in parallel with, a front-rear direction; and
when viewing the rebar tying tool in the front-rear direction, the guide member is disposed between the first illumination member and the second illumination member in a left-right direction, which is orthogonal to the front-rear direction.

7. The rebar tying tool according to claim 4, wherein, when viewing the rebar tying tool in a front-rear direction, the twisting member is disposed between the first illumination member and the second illumination member in a left-right direction, which is orthogonal to the front-rear direction.

8. The rebar tying tool according to claim 4, wherein the first illumination member and the second illumination member are spaced apart by a distance that is larger than the diameter of the rebars.

9. The rebar tying tool according to claim 1, wherein the luminous flux of the light emitted by the first illumination member is 1 lumen or more and 10,000 lumens or less.

10. The rebar tying tool according to claim 1, wherein the luminous-flux intensity of the light emitted by the first illumination member is 70 lux or more and 3,000 lux or less at a location that is 150 mm from the first illumination member in a direction of irradiation of the light.

11. The rebar tying tool according to claim 1, wherein the first illumination member comprises:
a light-emitting part, which emits light; and
a diffusion part, which diffuses the light emitted by the light-emitting part.

12. The rebar tying tool according to claim 1, further comprising:
a control unit configured to control driving of the twisting motor; and
a lead line electrically connecting the first illumination member with the control unit;
wherein:
the main-body housing comprises a grip part configured to be gripped by a user when the user is using the rebar tying tool, and
the lead line passes through the interior of the grip part.

13. The rebar tying tool according to claim 1, further comprising:
a feed motor configured to drive a feed member that feeds the wire; and
a control unit configured to control driving of the twisting motor and the feed motor; and
a lead line electrically connecting the first illumination member with the control unit;
wherein the main-body housing comprises a feed-motor housing part, which houses the feed motor; and
the lead line passes through the interior of the feed-motor housing part.

14. The rebar tying tool according to claim 1, wherein:
a control unit is configured to actuate the first illumination member, drive the twisting motor and execute a tying process for tying the wire around the two or more rebars; and
the control unit is configured or programmed to cause the first illumination member to emit light prior to executing the tying process.

15. The rebar tying tool according to claim 6, wherein:
a first irradiation range of light from the first illumination member partially crosses a second irradiation range of light from the second illumination member, such that shadows on a surface located on an opposite side of the rebars from the rebar tying tool are avoided or minimized;
when viewing the rebar tying tool in the front-rear direction, the twisting member is disposed between the first illumination member and the second illumination member in a left-right direction, which is orthogonal to the front-rear direction;
the first illumination member and the second illumination member are spaced apart by a distance that is larger than the diameter of the rebars;
the luminous flux of the light emitted by each of the first and second illumination members is 1 lumen or more and 10,000 lumens or less;
the luminous-flux intensity of the light emitted by at least the first illumination member is 70 lux or more and 3,000 lux or less at a location that is 150 mm from the first illumination member in a direction of irradiation of the light; and
each of the first and second illumination members comprises a light-emitting part, which emits the light, and a diffusion part, which diffuses the light emitted by the light-emitting part.

16. The rebar tying tool according to claim 15, further comprising:
a feed motor configured to drive a feed member that feeds the wire;
a control unit configured to control driving of the twisting motor and the feed motor; and
a lead line electrically connecting the first illumination member with the control unit;
wherein:
the main-body housing comprises a grip part configured to be gripped by a user when the user is using the rebar tying tool, and a feed-motor housing part, which houses the feed motor; and
the lead line passes through the interior of the grip part or through the interior of the feed-motor housing part.

17. A method for tying rebars using a wire, comprising:
shining light emitted from a rebar tying tool toward the rebars; and
actuating the rebar tying tool to twist the wire, which has been wound around the rebars, while the light continues illuminating the rebars.

18. A method of tying a wire around two or more rebars using a rebar tying tool, wherein:
the rebar tying tool comprises:
a twisting motor configured to drive a twisting member that twists the wire, which has been wound around the two or more rebars;
a trigger configured to be manipulated by a user to actuate the twisting motor;
a first illumination member configured to shine light toward the rebars; and
an actuating part configured to actuate the first illumination member;
the method comprising:
actuating the first illumination member in response to a signal from the actuating part; and
driving the twisting motor in response to manipulation of the trigger by the user to twist the wire and fasten the wire to the two or more rebars.

19. The method according to claim 18, wherein:
the first illumination member comprises a transmissive part, through which the light is transmitted from the interior of the first illumination member to the exterior of the first illumination member; and
a longest dimension of the transmissive part is larger than the diameter(s) of the two or more rebars.

20. The method according to claim 18, wherein:
the rebar tying tool further comprises a second illumination member configured to also shine light toward the rebars, and
the first illumination member and the second illumination member are spaced apart by a distance that is larger than the diameter of the rebars.
